(19) United States
(12) Patent Application Publication
(10) Pub. No.: US 2011/0053613 A1
(43) Pub. Date: Mar. 3, 2011

(54) Method of implementing location, method of broadcasting position information of neighbor base station and method of negotiating location capability

(75) Inventors: Lei Zhou, Beijing (CN); Xufeng Zheng, Beijing (CN); Sang-Heon Kim, Suwon-si (KR)

(73) Assignee: SAMSUNG ELECTRONICS CO., LTD., Suwon-si (KR)

(21) Appl. No.: 12/807,096

(22) Filed: Aug. 27, 2010

(30) Foreign Application Priority Data
Aug. 28, 2009 (CN) 200910171538.8

(51) Int. Cl. H04W 4/02

(52) U.S. Cl. 455/456.5; 455/456.2

(57) ABSTRACT

A method of implementing the location includes determining the base stations participating in the location and parameters required in the location via the signaling interaction between a mobile station and a serving base station. Afterwards, the mobile station and the base stations participating in the location perform the location measuring according to the determined parameters required in the location; at last, performing the location calculation according to the measuring result of location measuring.

### CROSS-REFERENCE TO RELATED APPLICATION(S) AND CLAIM OF PRIORITY

The present application claims the benefit under 35 U.S.C. §119(a) to a Chinese patent application filed in the Chinese Intellectual Property Office on Aug. 28, 2009 and assigned Serial No. 200910171538.8, the entire disclosure of which is hereby incorporated by reference.

### TECHNICAL FIELD OF THE INVENTION

The present invention relates to wireless location technology, and more particularly, to a method of implementing the location, a method of broadcasting the position information of neighbor base stations and a method of negotiating the location capability.

### BACKGROUND OF THE INVENTION

The study for wireless location technology began with the automatic vehicle location system of 1960s; afterwards, the technology has been widely used in public traffic, taxi dispatching and public security tracing. Thereafter, along with the rising position based information service demand required by the folks, the wireless location technology has been researched by more researchers. The existing of global position system (GPS) causes the qualitative leap of the wireless location technology. The location precision is greatly increased to within ten meters. Though a comparatively ideal location effect may be achieved by use of the GPS directly, GPS requires a special receiving device. Therefore, GPS may not be convenient for most users. In recent years, along with the popularization of the cellular mobile system, the location technology is used in cellular system design, such as, handover, service cell determination and traffic monitoring. At present, the wireless location may be divided into satellite wireless location and terrestrial wireless location. The satellite wireless location implements the three-dimensional location of mobile object using the satellite system including the GPS, the GLONASS and the Chinese big dipper binary star. The terrestrial wireless location implements the two-dimensional location of mobile object by measuring parameters of wireless wave including propagation time, signal field intensity, phase and incident angle. The cellular wireless location belongs to the terrestrial wireless location.

The wireless location system of the existing cellular mobile communication network is divided into the mobile communication network based wireless location, the mobile station based wireless location and the mixed wireless location according to the mobile communication structure. In recent years, along with the rapid increase of mobile users, the position-based service demand also is greatly increased. In a cellular system, there are many kinds of position-based services, such as, public security, position-based charging service, tracing service and route selecting service for enhancing a call. In the current cellular wireless location system, the mobile communication network based wireless location scheme is generally adapted to avoid increasing extra overhead of a mobile station. In the scheme, multiple base stations receive and detect signals sent by a mobile station at the same time, and the network performs the location estimation of mobile station according to the measured parameters. The mobile station can be a common mobile telephone. A monitoring device is installed at a base station. The monitoring device measures signal parameters sent by the mobile station, and estimates the approximate position of mobile station by use a proper algorithm; however, the signal propagation is dependent upon the character of mobile communication channel to a great extent, which greatly affects the location precision.

In the present standard of IEEE 802.16, there are two sets of signals for supporting the location:

The first set is scanning signaling including: scanning request (SCN-REQ) signals, scanning response (SCN-RSP) signal and scanning report (SCN-REP) signal; this set of signaling may be used in the downlink time difference of arrival (DL-TDOA) location method; and

The second set is uplink ranging signaling including: ranging request (RNG-REQ) signal and ranging response (RNG-RSP) signal; this set of signaling may be used in the uplink time difference of arrival (UL-TDOA) location method or may be used in measuring round-trip delay (RTD) of base station.

There are the following problems for performing the location by use of the above existing:

at first, the above first set of scanning signaling is mainly used in cell handover of mobile station; there are some signaling redundancies when the location service is performed by use of the scanning signaling. Such redundancies include:

indication elements associated with scanning in the scanning request signaling such as Scan duration, Interleaving interval, Scan Iteration and Scan type;

start frame indication, Scan duration, Interleaving interval, Scan Iteration and Scan type in the scanning response signaling;

number of current base station (N-current-BSs) and temp base station identifier (temp BSID) of the report of scanning report signaling; such parameters are all used for implementing fast base station switching (FBSS)/macro diversity handover (MDHO).

The above redundant indication elements or parameters only refer to the switching and scanning procedure, which are not required in the location service; when the above signaling is used as location signaling, however, such indication elements or parameters are inevitably transmitted; as a result, it is possible to cause the signaling redundancy and increase the overhead of system.

in a similar way, there are also many redundancy indication elements which are not required by the location server in the above second set of uplink ranging signaling, which causes the signaling redundancy and very large overhead when the location is performed by use of the uplink ranging signaling. Besides, the second set of signaling only supports the location triggered by the network, does not support the location triggered by a terminal.

Secondly, when the existing signaling is used in the location service, it is possible to cause that the feedback information of one side is impossible to reach the location requirement desired by the other side since the two sides of signaling is impossible to acquire the purpose of signaling completely. For example, if an MS sends a scanning request, a BS does not know that the intention of MS is used for location. If there is just one neighbor base station signal meeting the scanning requirement in the neighbor base station list of the BS, the BS sends the index or ID code of the base station to the MS; however, the MS needs information from at last two neighbor base stations. At this time, it is possible to cause that the MS is impossible to complete the location measurement and calculation.

In addition, the above two sets of signaling only can support a single location method; if it is required to support the mixed location method, it is possible to get the support of several sets of signaling at the same time, which increases the extra overhead. For example:

When the mixed location method of TDOA+angle of arrival (AoA)+time of arrival (ToA) is adapted, a base station (BS) requires acquiring the time difference of arrival (relative delay), and requires acquiring the angle of arrival and RTD; in this way, it is possible to determine which method can be used to determine the position of MS according to whether the MS resides in a cell center. For example, when an MS resides in a cell center, the AoA+RTD method is adapted; otherwise, the TDOA method is adapted. However, if the existing signaling is adapted, it is required to transmit the above two sets of signaling between a base station and a mobile station to get all required parameters. In this way, the system overhead can be very large; alternatively, the delay is relatively large when the two sets of signals are used. If there is an error in the transmission of signals, it is required to use the retransmission mechanism; as a result, it is possible to greatly reduce the system efficiency and it is also possible to reduce the throughput of the available information of system.

### SUMMARY OF THE INVENTION

To address the above-discussed deficiencies of the prior art, it is a primary object to provide a method of implementing the location measurement to reduce the signaling redundancy and the system overhead for use in the location measurement.

Another main objective of the present invention is to provide a method of broadcasting the position information of neighbor base stations such that a mobile station may acquire the position information of neighbor base station for use in the location measurement.

Yet another main objective of the present invention is to provide a method of negotiating a location capability between a base station and a mobile station.

To attain the above objectives, the embodiments of the present invention are as follows:

The present invention provides a method of implementing the location that includes:

determining base stations participating in the location and parameters required in the location via the signaling interaction between a mobile station and a serving base station;

performing, by the mobile station and the base stations participating in the location, the location measuring according to the determined parameters required in the location; and

performing the location calculation according to the measuring result of the location measuring.

The present invention further provides a method of implementing the location that includes:

sending, by a serving base station, a page broadcast signaling to a mobile station which is in idle state to trigger the location; the page broadcast signaling carries the location service indicating information and the location method indicating information.

The present invention further provides a method of broadcasting the position information of neighbor base stations that includes:

broadcasting, by a serving base station, to a mobile station a location broadcast signaling carrying the position information of neighbor base stations.

The present invention further provides a method of negotiating the location capability that includes:

sending, by a serving base station, to a mobile station a location capability negotiating request signaling to require acquiring the location capability that can be supported by the mobile station; and

sending, by the mobile station, to the serving base station a location capability response signaling carrying the location capability supported by the mobile station.

The present invention further provides a method of negotiating the location capability, that includes:

sending, by a mobile station, to a serving base station a system basic capability request signaling carrying the location capability supported by the mobile station; and

sending, by the serving base station, to the mobile station a system basic capability response signaling carrying the location capability supported by the serving base station after receiving the system basic capability request signaling.

The present invention further provides a method of implementing the location that includes:

sending, by a mobile station, to a serving base station a location trigger signaling carrying the information of the base stations participating in the location and the type of scanning signal; and

receiving, by the mobile station, a location request signaling returned by the serving base station; the location request signaling carries the response mode indicating information, the information of the base stations participating in the location, the type of a scanning signal, a scanning signal and parameters required in the location corresponding to the scanning signal.

The present invention further provides a method of implementing the location that includes:

sending, by a serving base station, a location request signaling to a mobile station; the location request signaling carries the response mode indicating information, the information of the base stations participating in the location, the type of a scanning signal, a scanning signal and the parameters required in the location corresponding to the scanning signal.

It can be seen from the above technical solution that, in the method of implementing the location in accordance with the present invention, the base stations participating in the location and the parameters required in the location are determined by the signaling interaction between a mobile station and a serving base station so as to clarify the method for use in the location; afterwards, the mobile station and the base stations participating in the location perform the location measuring according to the determined parameters required in the location to solve the problem that the feedback information of one side is impossible to reach the location requirement desired by the other side since the two sides of signaling are impossible to acquire the purpose of signaling completely in the prior art, and to solve the problem that the existing signaling can only support a single location method.

On the basis of the above technical solution, the mobile station and the serving base station provided by the present invention may further determine the location method via the signaling interaction; besides, the mobile station and the base stations participating in the location perform the location measuring according to the determined location method and the parameters required in the location. Since it may be determined to adopt any one or multiple existing location method in the prior art when the mobile station and the serving base station determine the location method, such as the mixed location method, it is needless to perform the location based on the mixed location method supported by several sets of signaling in the prior art, it is possible to save the signaling overhead and reduce the delay, thereby improving the system efficiency and the throughput of the system available information.

In addition, in accordance with the present invention, by providing a set of signaling for use in performing the location, it is possible to solve the problem that the redundancy of existing signaling and the system overhead are large, so as to improve the throughput of the system available information. Besides, in accordance with the signaling and method provided by the present invention, it is possible to support the uplink and downlink location at the same time; each location method supports the mobile station triggering and the network triggering, which improves the flexibility of location triggering.

In accordance with the method of negotiating the location capability provided by the present invention, it is possible to negotiate the location capability between a base station and a mobile station, and the mobile station and the base station may trigger the different location methods according to the location capability supported by two sides.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an indication element (IE) setting example of location broadcast signaling according to embodiments of the present invention;

FIG. 2 illustrates an IE setting example of location triggering signaling according to embodiments of the present invention;

FIG. 3 illustrates an IE setting example of location request signaling according to embodiments of the present invention;

FIG. 4 illustrates an IE setting example of location response signaling according to embodiments of the present invention;

FIG. 5 illustrates signaling in the downlink location method of embodiment 1 according to embodiments of the present invention;

FIG. 6 illustrates signaling in another downlink location method according to embodiments of the present invention;

FIG. 7 illustrates signaling in another uplink location method according to embodiments of the present invention;

FIG. 8 illustrates signaling in another uplink location method according to embodiments of the present invention;

FIG. 9 illustrates the interaction among the LBS-TRIGGER signaling, the LBS-REQ signaling and the LBS-RSP signaling according to embodiments of the present invention;

FIG. 10 illustrates a process for performing the location based on the Cell-ID when an MS is in idle state according to embodiments of the present invention;

FIG. 11 illustrates a process for performing the location based on the UL-TDOA when an MS is in idle state according to embodiments of the present invention;

FIG. 12 illustrates a process for performing the location based on the DL-TDOA when an MS is in idle state according to embodiments of the present invention;

FIG. 13 illustrates signaling for negotiating the location capability according to embodiments of the present invention;

FIG. 14 illustrates a process for implementing the location according to embodiments of the present invention.

### DETAILED DESCRIPTION OF THE INVENTION

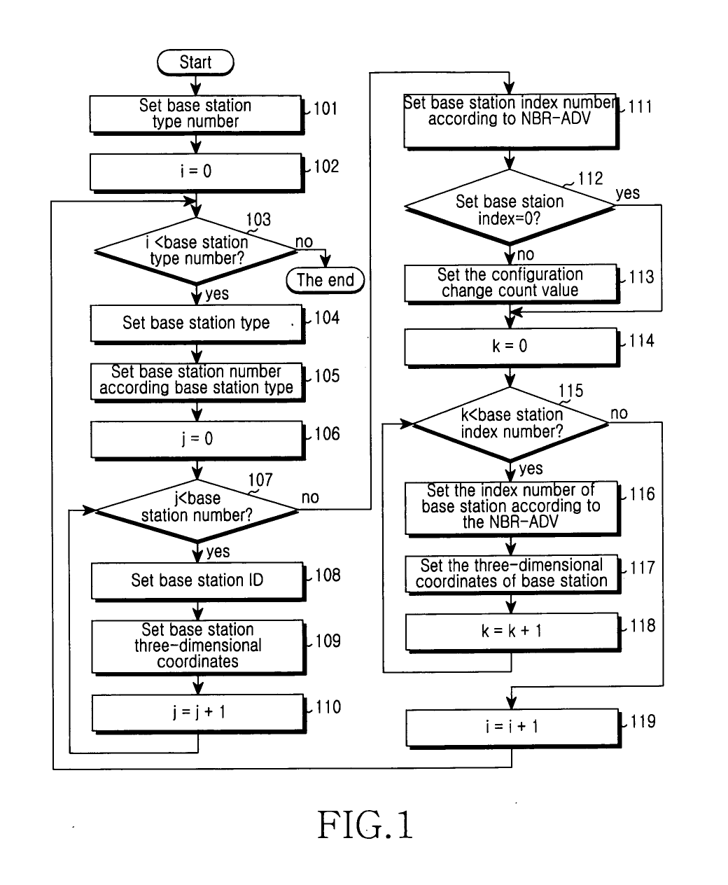

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is hereinafter further described in detail with reference to the accompanying drawings as well as embodiments so as to make the objective, technical solution and merits thereof more apparent.

Embodiments of the present disclosure include: determining the base station participating in the location and parameters required by the location via the signaling interaction between a mobile station and a serving base station; afterwards, performing, by the mobile station and the base station participating in the location, the location measurement according to the determined parameters required by the location; at last, performing the location calculation according to the measuring result of location measurement. In this way, since the mobile station and the serving base station have determined the base station participating in the location and the parameters required by the location before the location measurement is performed, it is possible to avoid the problem that the feedback information of one side of signaling interaction is impossible to reach the location requirement desired by the other side of signaling interaction in the prior art.

On the basis of the above technical solution, the mobile station and the serving base station may further determine the location method via the signaling interaction. The mobile station and the base station participating in the location perform the location measurement according to the determined location method and the parameters required by the location. Since it may be determined to adopt any one or multiple existing location methods when the mobile station and the serving base station determine the location method, such as the mixed location method, it is not necessary to perform the location based on the mixed location method supported by several sets of signaling in the prior art, it is possible to save the signaling overhead and reduce the delay, thereby improving the system efficiency and the throughput of the system available information.

In addition, in accordance with the present invention, by providing a set of signaling for use in performing the location, it is possible to solve the problem that the redundancy of existing signaling and the system overhead are large; alternatively, the mobile station may also actively trigger the location, which improves the flexibility and the application scope of location triggering.

Based on the above main idea, the method of implementing the location of the present invention is hereinafter described in detail.

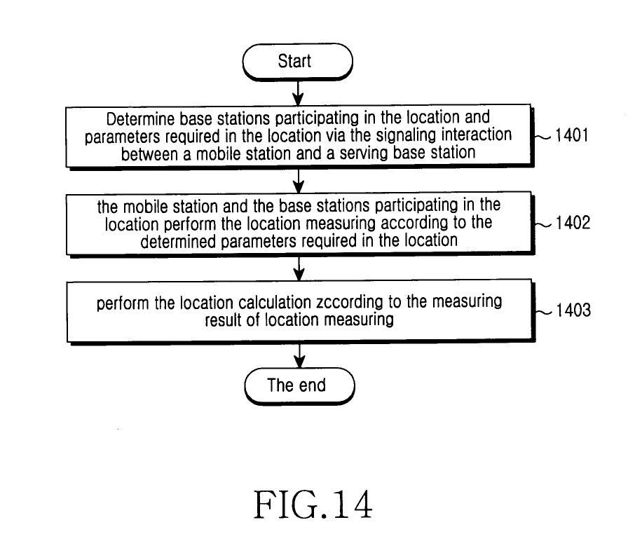

FIG. 14 illustrates a process for implementing the location in accordance with the present invention. Referring to FIG. 1, the method includes the steps of:

In block 1401: determining the base station participating in the location and parameters required by the location via the signaling interaction between a mobile station and a serving base station;

in block 1402: performing, by the mobile station and the base station participating in the location, the location measurement according to the determined parameters required by the location; and

in block 1403: performing the location calculation according to the measuring result of location measurement.

When a mobile station is in connection state, the location can be triggered by a serving base station. At this time, block 1401 as shown in FIG. 14, the serving base station sends, directly to the mobile station, a location request signaling to trigger the location. The location request signaling carries the response mode indicating information, the information of the base station participating in the location, the type of scanning signal, the scanning signal and the parameters required by the location corresponding to the scanning signal.

When a mobile station is in connection state, the location can also be triggered by the mobile station. At this time, block 1401 as shown in FIG. 14, may be divided into two steps: at first step includes sending, by a mobile station, to a serving base station, a location trigger signaling carrying the information of the base station participating in the location and the type of the scanning signal; afterwards, returning, by the serving base station, a location request signaling to the mobile terminal after receiving the location trigger signaling. The location request signaling carries the response mode indicating information, the information of the base station participating in the location, the type of scanning signal, the scanning signal and the parameters required by the location corresponding to the scanning signal.

The above response mode indicating information is used for indicating the response mode adapted by a mobile station when a serving base station indicates the mobile station to report the measuring result. When it is not necessary for a mobile station to report a measuring result, the response mode indicating information may be set corresponding to the value without reporting a measuring result, which makes the mobile station clarify that it is needless to report a measuring result; when it is required for a mobile station to report a measuring result, the response mode indicating information may be set as the response mode adapted when the mobile station reports a measuring result, which makes the mobile station clarify which response mode may be adapted to report a measuring result.

When it is required for a mobile station to report a location measuring result, a serving base station not only needs to set the response mode indicating information of the location request signaling as the response mode adapted when the mobile station reports a measuring result, but also needs to carry the response period and the response metric information in the location request signaling, which makes the mobile station clarify how to set a period to report a measuring result and it is necessary to report which measuring results. In this way, between block 1402 and block 1403, the mobile station may send to the serving base station a location response signaling carrying the location measuring result according to the response mode indicating information, the response period and the response metric information of the location request signaling. Afterwards, the serving base station sends the location measuring result of the location response signaling to the location server. At last, in block 1403, the location server performs the location calculation according to the location measuring result.

Corresponding to the above two triggering modes, the operations performed by the mobile station side and the serving base station side are hereinafter described in detail.

Operations when the location is triggered by a mobile station are as follows.

The operations performed by the mobile station include: at first, sending to a serving base station a location triggering signaling carrying the information of the base station participating in the location and the type of the scanning signal; afterwards, receiving a location request signaling returned by the serving base station; the location request signaling carries the response mode indicating information, the information of the base station participating in the location, the type of scanning signal, the scanning signal and the parameters required by the location corresponding to the scanning signal. When the received location request signaling further indicates that the mobile station needs to report a measuring result, the mobile station sends to the serving base station a location response signaling carrying the measuring result.

The operations performed by the serving base station include: at first, receiving the location triggering signaling carrying the information of the base station participating in the location and the type of the scanning signals sent by the mobile station; afterwards, returning a location request signaling to the mobile station; the location request signaling carries the response mode indicating information, the information of the base station participating in the location, the type of scanning signal, the scanning signal and the parameters required by the location corresponding to the scanning signal. If it is required for the mobile station to return a measuring result, the serving base station carries the corresponding indication in the location request signaling, and receives a location response signaling returned by the mobile station.

Operations when the location is triggered by a serving base station are as follows.

The operations performed by the mobile station include: receiving a location request signaling returned by the serving base station; the location request signaling carries the response mode indicating information, the information of the base station participating in the location, the type of scanning signal, the scanning signal and the parameters required by the location corresponding to the scanning signal. When the received location request signaling further indicates that the mobile station needs to report a measuring result, the mobile station sends to the serving base station a location response signaling carrying the measuring result.

The operations performed by the serving base station include: sending a location request signaling to the mobile station; the location request signaling carries the response mode indicating information, the information of the base station participating in the location, the type of scanning signal, the scanning signal and the parameters required by the location corresponding to the scanning signal. If it is required for the mobile station to return a measuring result, the serving base station carries the corresponding indication in the location request signaling, and receives a location response signaling returned by the mobile station.

The present invention further provides another location mode triggered by a serving base station, which is applicable to the case that an MS is in idle state; in the mode, the serving base station sends to a mobile station a page broadcast signaling carrying the location service indicating information and the location method indicating information, so as to trigger the location.

Considering that there is no method of knowing the location capability between a base station and a mobile station each other in the prior art, the present invention further provides a method of negotiating the location capability between a base station and a mobile station, so that it is possible for two sides to trigger the different location modes according to the location capability supported each other. To implement the method of negotiating the location capability between a serving base and a mobile station, the present invention provides two modes; a first mode includes: supporting the location capability negotiation by adding an indication element (IE) in the existing protocol; a second mode includes: redefining two signals for negotiating the location capability.

Based on the above description of the method of implementing the location of the present invention, the signaling provided for implementing the above method in accordance with the present invention is hereinafter described in detail.

To solve the existing problem in the prior art, the present invention provides four signals for performing the location when an MS is in connection state, and extends the existing page broadcast signaling to perform the location when an MS is in idle state; in addition, the preset invention further provides two signals for negotiating the location capability supported by an MS between the MS and a serving base station; the detailed descriptions are hereinafter given respectively.

The signals for performing the location when an MS is in connection state in accordance with the present invention mainly concentrate on the media access control (MAC) layer of R1 air interface. The present invention provides four MAC layer control signals including: location broadcast signaling (LBS-ADV), location triggering signaling (LBS-TRIGGER), location request signaling (LBS-REQ) and location response signaling (LBS-RSP). The above four MAC layer control signals are hereinafter described in detail.

1. Location Broadcast Signaling (LBS-ADV)

The LBS-ADV signaling is mainly used for a base station broadcasting the position information of neighbor base stations to an MS. When the location is not triggered by use of the MAC layer signaling provided by the present invention but is triggered directly by a higher layer signaling, the MS may also acquire the position information by directly receiving the LBS-ADV signaling, and perform the location measurement and calculation according to the acquired position information and other signals (such as a neighbor base station broadcast signaling).

In the LBS-ADV signaling example provided by the present invention, the position information of neighbor base station is represented by use of the form of type/length/value information; the type/length/value information may include: the position information of base station (absolute position or relative position), GPS time and frequency precision. In a practical application, the position information of neighbor base station may also be represented by other forms as required, such as by directly using the indication element form.

The LBS-ADV signaling may further carry the number information of base station type and the base station type information apart from containing the position information of neighbor base station, which makes the MS clarify how many types of neighbor base stations there are and the base station type to which each neighbor base station belongs. Of course, in a practical application, it may be unnecessary to carry such information.

To carry the position information of neighbor base stations in the LBS-ADV signaling, the present invention provides two different modes.

The first mode includes: carrying the position information of neighbor base stations in the LBS-ADV signaling by providing the corresponding relation between the base station ID and the position information. Corresponding to the method, to each base station type, the total number, base station ID and position information of the neighbor base stations belonging to the type are given in the LBS-ADV signaling.

The second mode includes: carrying the position information of neighbor base stations in the LBS-ADV signaling by providing the corresponding relation between the index number of neighbor base station and the position information. Corresponding to the method, to each base station type, the total number of the neighbor base stations belonging to the type, the base station index number of each neighbor base station and the position information of the neighbor base station corresponding to each base station index number are given according to the base station index Table of the neighbor base station information broadcast signaling (NBR-ADV). Since an MS may acquire the corresponding relation between the base station index number and the base station ID according to the NBR-ADV, it is not necessary to deliver the base station ID in the mode and it is possible to save the bit resources effectively.

In the LBS-ADV signaling, the position information of neighbor base stations may be carried by these two modes at the same time, or may be carried by any one mode; correspondingly, the information carried by the LBS-ADV signaling may be different along with the different modes.

In addition, to compress the bit occupied by the base station IDs of neighbor base stations, a configuration change count value may be carried in the LBS-ADV signaling; the count value may be set with reference to the corresponding count value in the NBR-ADV signaling and may be used for representing the NBR-ADV signaling referenced when the signaling is set. Therefore, the count value is optional information for a LBS-ADV signaling.

Based on the above discussion, the LBS-ADV signaling provided by the present invention may include the follow information as shown from a) to h). It should be noted that, it is not required to carry all the following information in the LBS-ADV signaling; the necessity of each information is described above.

a) number of base station type (referred to as Number_of_BS_Type) for representing the total number of base station type.

For example, supposing that the system supports four kinds of base station types including: macro cell BS, micro cell BS, femto cell BS and relay station, preferably, two bits may be used for representing the number of the base station type. The more base station types supported by the system, the more the bit numbers that are necessary for representing the number of the base station type; therefore, the bit number occupied by the base station type may be set according to the requirement of practical application. Besides, the mode adapted for representing the number of the base station type in this signaling may be determined according to the requirement of practical application.

b) base station type (referred to as BS type) for representing the base station type. The length may be set according to the number of base station type in a practical application. According to the example of a), two bits may also be used herein for representing the base station type.

c) number of base station (referred to as Number_of_BS) for representing the total number of the neighbor base stations belonging to each base station type. The information may typically occupy eight bits.

d) base station ID (BSID) is an unique ID. It may typically occupy twenty four bits.

e) number of base station index (referred to as Number_of_BS_Index) for representing the total number of the neighbor base stations belonging to each base station type, which is calculated and set according to the base station index of the NBR-ADV. It may be typically represented by eight bits.

f) type/length/value TLV encoded information.

i. Absolute Position, long type, three-dimensional coordinates of neighbor base station, which is the absolute position information of neighbor base station and is used while the short type absolute position is not used;

ii. Absolute Position, short type, three-dimensional coordinates of neighbor base station, which is the absolute position information of neighbor base station and is used while the long type absolute position is not used;

iii. Relative Position, which is the position of neighbor base station relative to the serving base station;

iv. GPS time for location synchronization;

v. Frequency Accuracy for representing the frequency precision of location.

g) base station index number of neighbor base station (referred to as Neighbor_BS_Index), which is the base station index number of neighbor base station in the NBR-ADV and typically represented by use of eight bits.

h) configuration change count value (referred to as Configuration change count for NBR-ADV); the count value may be set with reference to the corresponding count value in the NBR-ADV signaling and may be used for representing the NBR-ADV signaling referenced when the signaling is set to compress the bits occupied by the ID code of neighbor base stations. The NBR-ADV signaling is a periodic delivered signaling; the count value is added one when the content of the NBR-ADV signaling is updated. Supposing that an MS finds the configuration change count value is not identical with the corresponding count value of the received NBR-ADV signaling after receiving this signaling, it is represented that it is necessary to update the currently-received LBS-ADV signaling; at this time, the LBS-ADV signaling may be received again. For example, an MS may determine whether the neighbor base station index number used in this signaling is identical with that of the newest NBR-ADV signaling according to the count value; therefore, this signaling may not carry the ID code of the neighbor base station but, instead, carry the index number of the neighbor base station, so as to achieve the objective for compressing the bits occupied by the ID code of the neighbor base station. This information is not the necessary information in a location broadcast signaling. The indication element (IE) included by the LBS-ADV signaling of the present invention is as shown in Table 1.

TABLE 1

| Syntax | Other |
|---|---|
| Number_of_BS_Type | The number of base station type determined |
| | according to the NBR-ADV |
| BS type | Base station type (e.g. Macro cell; Micro cell; |
| | Femto cell (home cell); Relay station) |
| Number_of_BS | The number of the base stations belonging to |
| | each type |
| BSID | Base station ID Code |
| Number_of_BS_Index | The number of base station index |
| Configuration change | the count value may be set with reference to the |
| count for NBR-ADV | corresponding count value in the NBR-ADV |
| | signaling and may be used for representing the |
| | NBR-ADV signaling referenced when the |
| | signaling is set |
| Neighbor_BS_Index | The neighbor base station index |
| TLV encoded | — |
| information | |

Based on the above description of the information included by the location broadcast signaling of the present invention, the IE setting procedure of the location broadcast signaling of the present invention may be hereinafter described with reference to the procedure as shown in FIG. 1. In this example, the description is given by taking the procedure for adapting two methods for carrying the position information of neighbor base stations in the same LBS-ADV signaling at the same time for example. In this example, the main idea of IE setting procedure of location broadcast signaling includes: broadcasting the types, IDs and position information of neighbor base stations; calculating the base station type, and calculating the number of base station according to the base station type on broadcasting the associated information of neighbor base stations; in this way, an MS may select a base station according to the demand for the base station type. As shown in FIG. 1, the IE setting procedure includes:

In block 101 calculating the total number of neighbor base station type, and setting the number of base station type of the location broadcast signaling according to the total number of neighbor base station type.

For each base station type, the associated information of the neighbor base stations belonging to the type is hereinafter given by blocks 102-109; therefore, a loop is set by blocks 102 and 103, and the associated information of the neighbor base stations belonging to each type is given by blocks 104-119 within the loop body.

Initializing a count variable i, and setting i=0 occurs in block 102.

In block 103, it is determined whether i is less than the number of base station type, if is less than the number of base station type, performing block 104; otherwise, terminating this procedure.

A base station type is set in block 104.

In the following blocks 105-110, the position information of neighbor base stations is carried in the location broadcast signaling by using the above first mode.

In block 105, the total number of neighbor base stations belonging to the current base station type is calculated, and the number of base station of the location broadcast signaling is set according to the total number of neighbor base stations belonging to the current base station type.

In block 106 initializing a count variable j, and setting j=0.

In block 107: determining whether j is less than the number of base station, if j is less than the number of base station, performing block 108; otherwise, performing block 111.

In blocks 108 and 109, the base station ID and three-dimensional coordinates of each neighbor base station belonging to the current base station type is given in turn.

A base station ID is set in block 108.

In block 109: showing the three-dimensional coordinates of the base station corresponding to the base station ID of block 108.

In block 110: adding one to variable j, and returning to block 107.

In blocks 111-118, the position information of neighbor base stations is carried in the location broadcast signaling by using the above second mode.

In block 111: the total number of neighbor base stations belonging to the current base station type according to the NBR-ADV is calculated, and the number of base station index is set according to the total number of neighbor base stations belonging to the current base station type.

In block 112: determining whether the number of base station index is equal to 0, if the number of base station index is not equal to 0, performing block 113; otherwise, performing block 114.

In block 113: setting a configuration change count value with reference to the corresponding count value of the NBR-ADV signaling.

In block 114: initializing a count variable k, and setting k=0.

In block 115: determining whether k is less than the number of base station index, if k is less than the number of base station index, performing block 116; otherwise, performing block 119.

In blocks 116 and 117, the base station index number and three-dimensional coordinates of each neighbor base station, determined according to the NBR-ADV, belonging to the current base station type is given in turn.

In blocks 116: setting the number of base station index of a neighbor base station.

In block 117: showing the three-dimensional coordinates of the base station corresponding to the number of base station index of block 116.

In block 118: adding one to variable k, and returning to block 115.

In block 119: adding one to variable i, and returning to block 103.

Then, the IE setting procedure of location broadcast signaling of the present invention is terminated.

2. Location Trigger Signaling (LBS-TRIGGER)

An MS mainly uses a LBS-TRIGGER signaling to request to a base station for location and to indicate the information of the base station participating in the location and the type of scanning signal.

The above information of the base station participating in the location indicates the associated information of the base station participating in the location recommended by the MS. The associated information may include the information for identifying a neighbor base station uniquely such as the base station ID of neighbor base station or the number of base station index of neighbor base station determined according to the NBR-ADV signaling, may further include the number of base station and the base station type.

To carry the associated information of the base stations participating in the location in the LBS-TRIGGER signaling, the present invention provides two preferred mode.

The first mode is a bit mapping mode, and more particularly is to pre-assign a section of base stations, of which the length of section is preset, starting from a position in the base station index Table of the NBR-ADV signaling to participate in the location; in this case, it is only necessary to notify the length set by the BS (that is to say the bit number used by bit mapping, i.e., the bit mapping length corresponding to the neighbor cell broadcast signaling), two sides of the MS and the BS may determine to use which part base stations of the base station index Table to participate in the location. The MS may further notify the BS to use selected base stations of this part of the base station index Table to participate in the location via the bit mapping index corresponding to the neighbor cell broadcast signaling, and give the types of the scanning signals adopted corresponding to these base stations. Preferably, the base station type of these base stations and the total number of the base stations participating in the location may further be given.

The second mode is a count mode, the index number of each neighbor base station participating in the location and the adopted scanning signaling type corresponding to these base stations are given in turn according to the base station index Table of the NBR-ADV signaling. Preferably, the base station type of these base stations and the total number of the base stations participating in the location may further be given.

In the LBS-TRIGGER signaling, the associated information of the base stations participating in the location may be carried by these two modes at the same time, or may be carried by any one mode; correspondingly, the information carried by the LBS-TRIGGER signaling may be different along with the different modes.

To let an MS and the serving base station clarifying the location method adopted in the location, the location method type information may be carried in the LBS-TRIGGER signaling in accordance with the present invention to indicate the adopted location method.

To mark a location trigger signaling sent by an MS, a trigger sequence ID may be carried in the LBS-TRIGGER signaling in accordance with the present invention.

In addition, to compress the bits occupied by the BS ID of neighbor base station, a configuration change count value may be carried in the LBS-TRIGGER signaling in accordance with the present invention.

Based on the above discussion, the LBS-TRIGGER signaling provided by the present invention may include the follow information as shown from a) to i). It should be noted that, it is not required to carry all the following information in the LBS-TRIGGER signaling; the necessity of each information is described above.

a) location method type (referred to as LBS_method_type) for representing the adopted location method. The information may be not included in the location trigger signaling.

The number of bits occupied by the location method type and the location method required by the MS may be determined according to the requirement of practical application. Herein, the location method may include a location method based on cell ID, and a mixed method of DL-TDOA, UL-TDOA, DL-TDOA and TOA.

b) recommended number of base station (referred to as N_Recommended_BS_Index) for representing the total number of the base stations, participating in the location, recommended by the MS.

If an MS carry the information of the base stations participating in the location by use of the above first mode, the BS may be notified by setting the N_Recommended_BS_Index as a preset special value; otherwise, the IE may be set according to the practically-recommended number of base stations.

c) trigger sequence ID (referred to as Tri_Seq_Num), the IE is an optional ID, which occupies one bit and is used for marking the location trigger signaling. To construct a location trigger signal, an MS marks each newly-constructed location trigger signal by using the trigger sequence ID and stores the ID; after receiving a location request signaling from the BS, the MS determines whether the trigger sequence ID (Tri_Seq_Num) of the location request signaling is identical to the stored request sequence ID (Tri_Seq_Num); if the trigger sequence ID (Tri_Seq_Num) of the location request signaling is not identical to the stored request sequence ID (Tri_Seq_Num), the location response signaling is discarded.

d) bit mapping length corresponding to the neighbor cell broadcast signaling (referred to as Nbr_Bitmap_Size); the IE represents the bit number used during bit mapping when the neighbor cell base station is represented by use of the above first mode (i.e., bit mapping mode).

e) bit mapping index corresponding to the neighbor cell broadcast signaling (referred to as Nbr_Bitmap_Index) for representing the index indication of the neighbor cell base station when the neighbor cell base station is represented by use of the bit mapping mode; true is adopted and false is not adopted, which is indicated by use of one bit; true may be represented by use of 0 or 1, which is pre-assigned. When a bit is set as true, it represents that the base station corresponding to the bit is selected. The index number is identical to that of the base station of the NBR-ADV.

f) base station type (BS type) including: Macro cell, Micro cell, Femto cell and Relay station; the bit number occupied by the base station type may be set according to the requirement of practical application. The information may be not included in the location trigger signaling.

g) base station index number of neighbor base station (Neighbor_BS_Index) for giving the index number of neighbor base station when the neighbor cell base station is represented by use of the above second mode; the index number is identical to the base station index number of the NBR-ADV and is typically represented by use of eight bits.

h) scanning signal type (referred to as Scanning_Signal_type) for representing the type of scanning signal; the scanning signal is used for measuring the parameters required in the location.

At present, there are three kinds of supported scanning signals including: Preamble (including: PA-preamble: primary preamble sequence, SA-Preamble: supplementary preamble sequence or Femtocell Preamble: femto cell preamble sequence), Reference Signal and Ranging. The scanning signal type may be represented by use of the bit mapping mode or bu use of the mode for different values corresponding to different scanning signal types. Supposing that it is represented by use of the bit mapping mode, for example, bit[0] corresponding to Preamble, bit[1] corresponding to Ranging; the scanning signal type may support these three kinds of signals at the same time; other types of scanning signals may be added into the scanning signal type as long as the corresponding bit is added to represent other types of scanning signals. For example, adding a reference signal, which may be represented by use of bit[2]. The content represented by bits is not limited by the description in accordance with the present invention and the order of the represented content may be random arranged.

i) configuration change count value (referred to as Configuration change count for NBR-ADV); the count value may be set with reference to the corresponding count value in the NBR-ADV signaling and may be used for representing the NBR-ADV signaling referenced when the signaling is set to keep the NBR-ADV signaling referenced by two sides are identical during the subsequent interaction with the BS, thereby achieving the objective of compressing the bits occupied by the ID code of neighbor base stations. The ID is an optional IE.

The IE included in the location trigger signaling of the present invention is as shown in Table 2.

TABLE 2

| Syntax | Other |
|---|---|
| LBS_method_type | Location mehto type(e.g. Cell-ID, D-TDOA, U-TDOA, |
| | handover method (such as D-TDOA + TOA)) |
| N_Recommended_BS_Index | The number of recommended base station index |
| Configuration change count for | the count value may be set with reference to the |
| NBR-ADV | corresponding count value in the NBR-ADV signaling |
| | and may be used for representing the NBR-ADV signaling |
| | referenced when the signaling is set |
| Tri_Seq_Num | Request sequenct ID |
| Nbr_Bitmap_Size | The bit length of bit mapping of neighbor base stations |
| Nbr_Bitmap_Index | The neighbor base station index |
| BS type | Base station type (e.g. Macro cell; Micro cell; Femto cell |
| | (home cell); Relay station) |
| Scanning_Signal_type | The scanning signa type |
| Neighbor_BS_Index | The neighbor base station index |

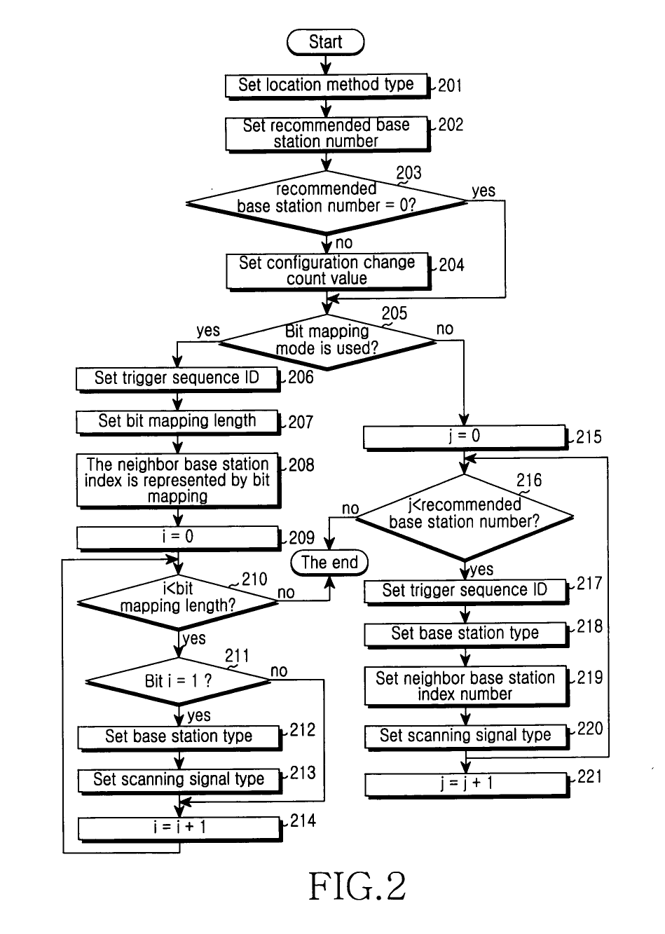

Based on the above description of the information included by the location trigger signaling of the present invention, the IE setting procedure of the location trigger signaling of the present invention may be hereinafter described with reference to the procedure as shown in FIG. 2. In this example, the description is given by taking the procedure for adapting two methods for carrying the associated information of base stations participating in the location in the same location trigger signaling at the same time for example. In this example, the main idea of the IE setting procedure of the location trigger signaling is that, the signaling is sent from an MS to a BS; the signaling mainly indicates the information of the neighbor base stations, recommended by the MS, participating in the location, the base station type of neighbor base stations and the type of scanning signal, which are all the information necessary for the location. As shown in FIG. 2, the IE setting procedure includes:

Block 201: setting a location method type.

Block 202: setting a recommended number of base station.

It is described above that, if an MS carry the information of the recommended base stations participating in the location by use of the above first mode, the BS may be notified by setting the N_Recommended_BS_Index as a preset special value (e.g., full one represented by binary system); otherwise, the IE may be set according to the practically-recommended number of base stations.

Block 203: determining whether the recommended number of base stations is equal to 0, if the recommended number of base stations is not equal to 0, performing block 204; otherwise, performing block 205.

Block 204: setting a configuration change count value with reference to the corresponding count value of the NBR-ADV signaling.

Block 205: determining whether the associated information of neighbor base stations is given by use of bit mapping mode; if the associated information of neighbor base stations is given by use of bit mapping mode, performing block 206; otherwise, performing block 215.

Herein, whether the associated information of neighbor base stations is given by use of bit mapping mode may be determined by determining whether the recommended number of base station is set a preset special value. For example, if it is preset that, it represents to adopt the bit mapping mode when the recommended number of base stations is set as full one represented by binary system; therefore, this step is to determine whether the recommended number of base stations is identical to full one represented by binary system.

In the following blocks 206-214, the information of neighbor base stations participating in the location is carried in the location trigger signaling by using the above first mode.

Block 206: setting a trigger sequence ID.

Block 207: setting a bit mapping length.

Block 208: representing the neighbor base station index by use of bit mapping mode.

Supposing that setting the bit of bit mapping as 1 represents the base station corresponding to the bit is represented to participate in the location, this step is to set the bit corresponding to the base station recommended to participate in the location in the bit mapping as 1.

Block 209: initializing a count variable i, and setting i=0.

Block 210: determining whether i is less than the bit mapping length, if i is less than the bit mapping length, performing block 211; otherwise, terminating this procedure.

Block 211: determining whether the bit in the bit mapping corresponding to the current value of i is set as 1, if the bit in the bit mapping corresponding to the current value of i is set as 1, performing block 212; otherwise, performing block 214.

Block 212: setting a base station type according to the base station corresponding to the current value of i.

Block 213: setting a type of scanning signal to the base station corresponding to the current value of i.

Herein, the type of scanning signal may be given by use of bit mapping mode. For example:

Eight bits may be used to perform the bit mapping;

Bit 0 represents the type of scanning signal is Preamble; the PA-preamble, SA-Preamble or Femtocell Preamble may be adopted according to the different base station types.

Bit 1 represents the type of scanning signal is Reference Signal;

Bit 2 represents the type of scanning signal is Ranging;

Bit 3 represents No scanning;

Bits 4-7 may be reserved.

Block 214: adding one to i, and returning to block 210.

In the following blocks 215-221, the information of neighbor base stations participating in the location is carried in the location trigger signaling by using the above second mode.

Block 215: initializing a count variable j, and setting j=0.

Block 216: determining whether j is less than the recommended number of base station, ifj is less than the recommended number of base station, performing block 217; otherwise, terminating this procedure.

Block 217: setting a trigger sequence ID.

Block 218: setting a base station type.

Block 219: setting a base station index number of neighbor base station; the base station index number is identical to the base station index Table of the NBR-ADV.

Block 220: setting a type of scanning signal to the current neighbor base station.

Herein, the type of scanning signal may be set by use of the above bit mapping mode.

Block 221: adding one to j, and returning to block 216.

Up to now, the IE setting procedure of location trigger signaling of the present invention is terminated.

3. Location Request Signaling (LBS-REQ)

The LBS-REQ signaling may be used for a base station actively initiating the location, or be used for a base station responding to the LBS-TRIGGER sent by an MS. In this signaling, a base station may notify an MS of the location method (for BS triggering mode), the response mode indicating information, the type of scanning signal, the scanning signal and the parameters required in the location corresponding to the scanning signal. When it is required for an MS to feed back a location measuring report, it is necessary to notify the MS of feeding back which measuring parameters, the response period and the response mode in the signaling.

The present invention provides three modes for a base station sending the above information to an MS,

The first mode is to send according to the base station bit mapping relation of the NBR-ADV signaling;

The second mode is to send according to the base station index (i.e. count mode);

The third mode is to send according to the base station bit mapping relation of the location trigger signaling.

In the LBS-REQ signaling, the associated information may be carried by the above three modes at the same time, or may be carried by any one or two mode; correspondingly, the information carried by the LBS-REQ signaling may be different along with the different adopted modes. When a base station actively initiates the location by sending the LBS-REQ signaling, the above three modes do not exist, and it is needless to carry the corresponding IE in the LBS-REQ signaling.

When the LBS-REQ signaling is a response of a LBS-TRIGGER signaling, the trigger sequence ID may be carried in the LBS-REQ signaling.

To mark a location request signaling sent by an MS, a request sequence ID may be carried in the LBS-REQ signaling in accordance with the present invention.

In addition, to compress the bits occupied by the BS ID of neighbor base station, a configuration change count value may be carried in the LBS-REQ signaling in accordance with the present invention.

Based on the above discussion, the LBS-REQ signaling provided by the present invention may include the follow information as shown from a) to v).

a) location method type (LBS_method_type) for representing the adopted location method. This information is not the necessary information in a location request signaling.

b) response mode indicating information for indicating the mode for an MS reporting a measuring result, including: per-request Response, Periodic Response, Event-triggered Response, no response.

c) base station index bit mapping indication (Use_Nbr_Bitmap_Index) indicating whether to use the base station index bit mapping of the NBR-ADV.

d) base station index bit mapping indication (Use_Tri_Bitmap_Index) indicating whether to use the base station index bit mapping of the NBR-TRIGGER.

In the above two indications, true is adopted and false is not adopted, which is indicated by use of one bit; true may be represented by use of 0 or 1, which is pre-assigned.

e) response period, if the signaling is not a response of the location trigger signaling, the response period is set as the period for the serving base station suggesting the MS to report a measuring result before receiving the next location request signaling; if the signaling is a response of the location trigger signaling, the response period is set as the period for the base station suggesting the MS to report a measuring result before sending the next location trigger signaling. Correspondingly, according to the different response modes, there are different response periods, which may be set according to the requirement of practical application. If it is unnecessary for an MS to report a measuring result, the IE may be not carried.

f) request sequence ID (Req_Seq_Num), the IE is an optional ID, which occupies one bit and is used for marking the location request signaling. To construct a location request signaling, a BS marks each newly-constructed location request signaling by use of the request sequence ID and stores the ID; after receiving a location response signaling from an MS, the BS determines whether the response request sequence ID of the location response signaling is identical to the stored request sequence ID; if the response request sequence ID of the location response signaling is not identical to the stored request sequence ID, the location response signaling is discarded.

g) response metric, for indicating the measuring result that should be reported by an MS, the response metric may include: the carrier interference and noise ratio mean of neighbor base station (BS CINR mean), receiving signal strength indication mean of neighbor base station (BS RSSI mean), relative delay, the round-trip delay of serving base station (BS RTD). According to requirement of practical application, response metric may further include receiving signal strength indication mean of serving base station (SBS RSSI mean).

h) recommended number of base station (N_Recommended_BS_Index); the IE should be carried when the associated information is carried by use of the above second mode. If the LBS-REQ is a response of the LBS-TRIGGER, the recommended number of base station in this signaling is identical to that of the LBS-TRIGGER; if the LBS-REQ is the location initiated by the base station actively, the recommended number of base station may be set according to the requirement of practical application.

i) bit mapping length corresponding to the neighbor cell broadcast signaling (referred to as Nbr_Bitmap_Size); the IE represents the bit number used during bit mapping when the neighbor cell base station is represented by use of the above first mode (i.e. bit mapping mode).

j) bit mapping index corresponding to the neighbor cell broadcast signaling (referred to as Nbr_Bitmap_Index) for representing the index indication of the neighbor cell base station when the neighbor cell base station is represented by use of the bit mapping mode; true is adopted and false is not adopted, which is indicated by use of one bit; true may be represented by use of 0 or 1, which is required to be preassigned. When a bit is set as true, it represents that the base station corresponding to the bit is selected. The index number is identical to that of the base station of the NBR-ADV.

k) bit mapping length corresponding to the location trigger signaling (referred to as Tri_Bitmap_Size); the IE represents the bit number used during bit mapping when the neighbor cell base station is represented by use of the above third mode (i.e. bit mapping mode).

1) bit mapping index corresponding to the location trigger signaling (referred to as Tri_Bitmap_Index) for representing the index indication of the neighbor cell base station when the neighbor cell base station is represented by use of the above third kind of bit mapping mode; true is adopted and false is not adopted, which is indicated by use of one bit; true may be represented by use of 0 or 1, which is required to be preassigned. When a bit is set as true, it represents that the base station corresponding to the bit is selected. The index number is identical to that of the base station of the LBS-TRIGGER.

m) configuration change count value (referred to as Configuration change count for NBR-ADV); the IE is an optional IE and is used for representing the NBR-ADV signaling referenced when the signaling is set to compress the bits occupied by the ID code of neighbor base stations. When the location request signaling is a feedback of a location trigger signaling, the configuration change count value is identical to that of the location trigger signaling; when the location request signaling is not a feedback of a location trigger signaling, but is used for a base station actively triggering the location, the count value is set with reference to the corresponding count value of the NBR-ADV signaling. When the location request signaling is a feedback of a location trigger signaling, the MS may compare the stored configuration change count value with that of the location request signaling after receiving the location request signal; if they are not identical, the MS sends a location trigger signaling to the base station again, and sets the configuration change count value as 0 at the same time.

To each recommended base station participating in the location, the type of base station, the index number, the type of scanning signal are given and the corresponding parameters required in the location is given according to the different scanning types, which is as shown in o)-v).

n) base station type (BS type) including: Macro cell, Micro cell, Femto cell and Relay station; the bit number occupied by the base station type may be set according to the requirement of practical application. This information is not the necessary information in a location request signaling.

o) base station index number of neighbor base station (Neighbor_BS_Index) for giving the index number of neighbor base station when the neighbor cell base station sends the information of this signaling by use of the above second mode; the index number is identical to the base station index number of the NBR-ADV and is typically represented by use of eight bits.

p) scanning signal type (Scanning_Signal_type) for representing the type of scanning signal; the scanning signal is used for measuring the parameters required in the location.

At present, the supported scanning signals includes: Preamble and Ranging. The type of scanning signal may support these two signals at the same time. For example, it is represented by use of the bitmap mode, bit[0] corresponding to Preamble, bit[1] corresponding to Ranging; other signals may be added into the scanning signal type as long as the corresponding bit is added to represent other signals. For example, the added Reference Signal may be represented by use of bit[2]; the content represented by bits is not limited by the description in accordance with the present invention and the order of the represented content may be random arranged.

q) scanning signal, the used Preamble index, the Ranging index or other signal (e.g., Reference signal) index are given in detail according to the set scanning signal type, so that an MS may determine the parameters required in the location according to the set scanning signal.

r) base station effective isotropic radiated power (BS EIRP), the IE is an optional IE; when the type of scanning signal is Preamble or reference signal, the corresponding BS EIRP should be given.

s) signal rendezvous time (Rendezvous_time); the interval time after an MS receives the location request signaling and before the MS sends the Ranging code. The IE is an optional IE, which is carried in the LBS-REQ signaling when the type of scanning signal is a ranging signal.

t) Ranging code, that is, a Ranging signal, may be a CDMA code or other orthogonal sequences. The IE is an optional IE, which is carried in the LBS-REQ signaling when the type of scanning signal is a ranging signal.

u) transmission opportunity offset (Transmission_opportunity_offset) is the time offset for an MS sending a ranging signal, i.e., an MS may send an ranging signal within the range of the signal rendezvous time±the transmission opportunity offset. The IE is an optional IE, which is carried in the LBS-REQ signaling when the type of scanning signal is a ranging signal.

v) trigger sequence ID (Tri_Seq_Num), which is set according to the trigger sequence ID set by use of the first mode of the above location trigger signaling.

When the LBS-REQ signaling is used for a serving base station actively triggering the location, the IE and the syntax of each IE included in the LBS-REQ signaling of the present invention is as shown in Table 3.

TABLE 3

| Syntax | Other |
|---|---|
| LBS_method_type | The location method type (e.g. Cell-ID, D-TDOA, |
| | U-TDOA, handover method (such as D-TDOA + TOA)) |
| Response mode | The location response mode, including |
| | 0b00: requested response every time(request necessary |
| | for every time) |
| | 0b01: periodic response |
| | 0b10: event triggered response |
| | 0b11: no response |
| Response period | response period, if the signaling is not a response of the |
| | location trigger signaling, the response period is set as the |
| | period for the serving base station suggesting the MS to |
| | report a measuring result before receiving the next |
| | location request signaling; if the signaling is a response of |
| | the location trigger signaling, the response period is set as |
| | the period for the base station suggesting the MS to report |
| | a measuring result before sending the next location |
| | trigger signaling. |
| Response metric | Response parameters such as carrier interference and |
| | noise ratio mean of neighbor base station (BS CINR |
| | mean), receiving signal strength indication mean of |
| | neighbor base station (BS RSSI mean), relative delay, the |
| | round-trip delay of serving base station (BS RTD). |
| Use_Nbr_Bitmap_Index | indicating whether the bit mapping uses the base station |
| | index bit mapping of the NBR-ADV signaling. |
| Use_Tri_Bitmap_Index | indicating whether the bit mapping uses the base station |
| | index bit mapping of the LBS-TRIGGER signaling. |
| Req_Seq_Num | Request sequenct ID |
| Configuration change count for | the count value may be set with reference to the |
| NBR-ADV | corresponding count value in the NBR-ADV signaling |
| | and may be used for representing the NBR-ADV |
| | signaling referenced when the signaling is set |
| Nbr_Bitmap_Size | Corresponding to the bit mapping length of the neighbor |
| | cell broadcast signaling |
| Nbr_Bitmap_Index | Corresponding to the bit mapping index of the neighbor |
| | cell broadcast signaling |
| BS type | Base station type (e.g., Macro cell; Micro cell; Femto cell |
| | (home cell); Relay station) |
| Scanning_Signal_type | Scanning signal type(e.g. preamble, ranging, reference |
| | signal) |
| Preamble Index | Base station preamble index |
| BS EIRP | effective isotropic radiated power |
| Rendezvous_time | signal rendezvous time |
| Ranging code | uplink ranging signal |
| Transmission_opportunity_offset | Transmission opportunity offset |
| N_Recommended_BS_Index | The recommended number of base station |
| Neighbor_BS_Index | The neighbor base station index |
| Tri_Seq_Num | trigger sequence ID, which is set according to the trigger |
| | sequence ID set by use of the first mode of the above |
| | location trigger signaling. |
| Tri_Bitmap_Size | Corresponding to the bit mapping length of the location |
| | trigger signaling |
| Tri_Bitmap_Index | Corresponding to the bit mapping index of the location |
| | trigger signaling |

After receiving a location request sent by a location server (the location request sent by the location server may be the location server requires the position information of mobile station, or a mobile station sends a location request to the location server by a high-layer signaling), a serving base station directly trigger the location by sending a LBS-REQ signaling, and the LBS-REQ signaling does not carry the indication element associated with the third mode and the indication element associated with the location trigger signaling of mobile station. The detailed signaling indication element example is as shown in Table 4.

TABLE 4

| Syntax | Other |
|---|---|
| LBS_method_type | The location method type (e.g. Cell-ID, D-TDOA, |
| | U-TDOA, handover method (such as D-TDOA + TOA)) |
| Response mode | The location response mode, including |
| | 0b00: requested response every time(request necessary |
| | for every time) |
| | 0b01: periodic response |
| | 0b10: event triggered response |
| | 0b11: no response |
| Response period | Response period |
| Response metric | Response parameters such as carrier interference and |
| | noise ratio mean of neighbor base station (BS CINR |
| | mean), receiving signal strength indication mean of |
| | neighbor base station (BS RSSI mean), relative delay, the |
| | round-trip delay of serving base station (BS RTD). |
| Use_Nbr_Bitmap_Index | indicating whether the bit mapping uses the base station |
| | index bit mapping of the NBR-ADV signaling. |
| Req_Seq_Num | Request sequenct ID |
| Configuration change count for | the count value may be set with reference to the |
| NBR-ADV | corresponding count value in the NBR-ADV signaling |
| | and may be used for representing the NBR-ADV |
| | signaling referenced when the signaling is set |
| Nbr_Bitmap_Size | Corresponding to the bit mapping length of the neighbor |
| | cell broadcast signaling |
| Nbr_Bitmap_Index | Corresponding to the bit mapping index of the neighbor |
| | cell broadcast signaling |
| BS type | Base station type (e.g. Macro cell; Micro cell; Femto cell |
| | (home cell); Relay station) |
| Scanning_Signal_type | Scanning signal type(e.g. preamble, ranging, reference |
| | signal) |
| Preamble Index | Base station preamble index |
| BS EIRP | effective isotropic radiated power |
| Rendezvous_time | signal rendezvous time |
| Ranging code | uplink ranging signal |
| Transmission_opportunity_offset | Transmission opportunity offset |
| N_Recommended_BS_Index | The recommended number of base station |
| Neighbor_BS_Index | The neighbor base station index |

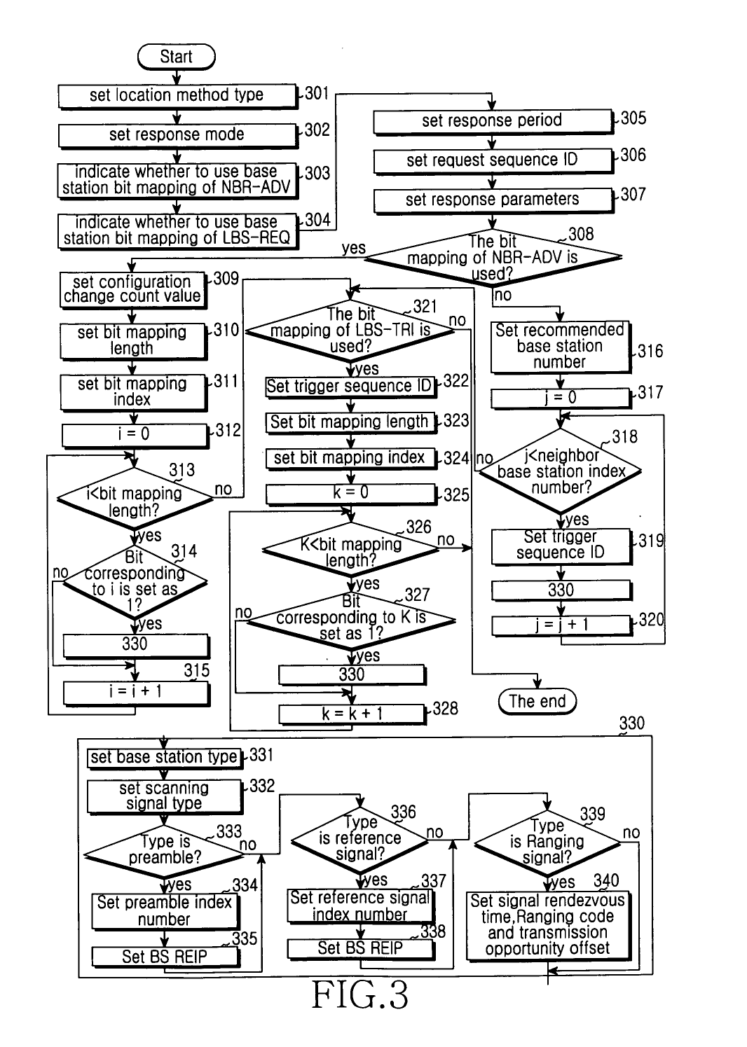

Based on the above description of the information included by the location request signaling of the present invention, the IE setting procedure of the location request signaling of the present invention may be hereinafter described with reference to the procedure as shown in FIG. 3. In this example, the description is given by adopting the above three mode carrying the associated information in the same LBS-REQ signaling for example; besides, supposing a serving base station requires an MS to return a measuring result in this example, the response period and the response parameter information should be carried in the LBS-REQ signaling. As shown in FIG. 3, the IE setting procedure includes:

Block 301: setting a location method type.

Block 302: setting a response mode.

Block 303: indicating whether to use the base station index bit mapping of the NBR-ADV.

Block 304: indicating whether to use the base station index bit mapping of the LBS-TRIGGER.

Block 305: setting a response period.

Block 306: setting a request sequence ID.

Block 307: setting a response parameter.

The type, the index number, the type of scanning signal and the associated parameters of each recommended base station participating in the location are hereinafter given by the above described three modes. Blocks 308-315 use the above first mode; blocks 316-320 use the above second mode, and blocks 321-328 use the above third mode.

Block 308: determining whether to use the base station index bit mapping of the NBR-ADV; if the base station index bit mapping of the NBR-ADV is used, performing block 309; otherwise, performing block 316.

Block 309: setting a configuration change count value.

Block 310: setting a bit mapping length corresponding to the NBR-ADV.

Block 311: representing the base station index by use of the bit mapping mode corresponding to the NBR-ADV.

Block 312: initializing a count variable i, and setting i=0.

Block 313: determining whether i is less than the bit mapping length corresponding to the NBR-ADV, if i is less than the bit mapping length corresponding to the NBR-ADV, performing block 314; otherwise, performing block 321.

Block 314: determining whether the bit in the bit mapping corresponding to the current value of i is set as 1, if the bit in the bit mapping corresponding to the current value of i is set as 1, performing block 330, afterwards performing block 315; otherwise, performing block 315.

Block 315: adding one to i, and returning to block 313.

Block 316: setting a recommended number of base station.

Block 317: initializing a count variable j, and setting j=0.

Block 318: determining whether j is less than the recommended number of base station, ifj is less than the recommended number of base station, performing block 319; otherwise, performing block 321.

Block 319: setting a trigger sequence ID, performing block 330, afterwards performing block 320.

Block 320: adding one to j, and returning to block 318.

Block 321: determining whether to use the base station index bit mapping of the LBS-TRIGGER; if the base station index bit mapping of the LBS-TRIGGER is used, performing block 322; otherwise, terminating this procedure.

Block 322: setting a trigger sequence ID.

Block 323: setting a bit mapping length corresponding to the LBS-TRIGGER.

Block 324: representing the base station index by use of the bit mapping mode corresponding to the LBS-TRIGGER.

Block 325: initializing a count variable k, and setting k=0.

Block 326: determining whether i is less than the bit mapping length corresponding to the LBS-TRIGGER, if i is less than the bit mapping length corresponding to the LBS-TRIGGER, terminating this procedure; otherwise, performing block 327.

Block 327: determining whether the bit in the bit mapping corresponding to the current value of k is set as 1, if the bit in the bit mapping corresponding to the current value of k is set as 1, performing block 330, afterwards performing block 328; otherwise, performing block 328.

Block 328: adding one to k, and returning to block 326.

In FIG. 3, the steps included in block 330 include:

Block 331: setting a base station type.

Block 332: setting a type of scanning signal to the current neighbor base station.

Block 333: determining whether the type of scanning signal is a preamble; if the type of scanning signal is a preamble, performing block 334; otherwise performing block 336.

Block 334: setting a preamble index number.

Block 335: setting a BS EIRP corresponding to the preamble.

Block 336: determining whether the type of scanning signal is a reference signal; if the type of scanning signal is a reference signal, performing block 337; otherwise performing block 339.

Block 337: setting a reference signal index number.

Block 338: setting a BS EIRP corresponding to the reference signal.

Block 339: determining whether the type of scanning signal is a ranging signal; if the type of scanning signal is a ranging signal, performing block 340; otherwise terminating this procedure.

Block 340: setting a signal rendezvous time, a Ranging code and a transmission opportunity offset corresponding to the ranging signal.

Up to now, the IE setting procedure of location request signaling of the present invention is terminated.

4. Location Response Signaling (LBS-RSP)

The LBS-RSP signaling is used for an MS returning a measuring result to a base station. In the signaling, an MS requires to report a measuring result required by a base station to the base station; the necessary IE included in the signaling is: response mode, response parameter and base station type. Other indication elements involved in reporting a measuring result are all optional IEs. The optional IE has two meanings; the first meaning is that, since the present invention provides three modes for reporting a measuring result, these three mode may not exist in the LBS-RSP signaling at the same time, i.e., the IEs corresponding to various modes do not exist in the LBS-RSP signaling at the same time; however, it is not excluded that three modes or any two modes may exist in the LBS-RSP signaling at the same time. The second meaning is that, it is unnecessary to carry some parameters in the LBS-RSP signaling; if some parameters are carried, the objective is to improve the precision of location method or solve some location problems. The IEs belonging to the second meaning include: the receiving signal strength indication (RSSI) and the carrier interference and noise ratio (CINR).

The present invention provides three modes for an MS reporting a measuring result to a base station,

The first mode is to report a measuring result according to the base station bit mapping relation of the NBR-ADV signaling;

The second mode is to report a measuring result according to the base station index (i.e. count mode);

The third mode is to report a measuring result according to the base station bit mapping relation of the LBS-REQ signaling.

Based on the above discussion, the LBS-RSP signaling provided by the present invention may include the follow information as shown from a) to q).

a) response mode including: per-request response, periodic response and event-triggered response.

b) response metric, for indicating the parameters, i.e., the measuring result, reported by the signaling; in the prior art, the parameters that can be reported may include: the carrier interference and noise ratio mean of neighbor base station (BS CINR mean), the receiving signal strength indication mean of neighbor base station (BS RSSI mean), the relative delay, the round-trip delay of serving base station (BS RTD) and the receiving signal strength indication mean of serving base station (SBS RSSI mean). It is not required for the IE to support such measuring results completely, for example the IE may support some measuring results such as the receiving signal strength indication mean of neighbor base station (BS RSSI mean) and the relative delay, or the receiving signal strength indication mean of neighbor base station (BS RSSI mean), the relative delay and the round-trip delay of serving base station (BS RTD). To support which measuring result is not limited, such measuring results may be randomly ranged and combined.

c) base station index bit mapping indication (Use_Nbr_Bitmap_Index) indicating whether to use the base station index bit mapping of the NBR-ADV. true is adopted and false is not adopted, which is indicated by use of one bit; true may be represented by use of 0 or 1, which is required to be preassigned. When the indication is true, it represents to use the base station index bit mapping of the NBR-ADV, i.e. reporting a measuring result by use of the above first mode.

d) base station index bit mapping indication (Use_Req_Bitmap_Index) indicating whether to use the base station index bit mapping of the LBS-REQ. true is adopted and false is not adopted, which is indicated by use of one bit; true may be represented by use of 0 or 1, which is required to be preassigned. When the indication is true, it represents to use the base station index bit mapping of the LBS-REQ, i.e. reporting a measuring result by use of the above third mode.

e) the number of neighbor base station index (N Neighbor_BS_Index), which is an optional IE and is used for representing the number of the neighbor base station evolved in the signaling; the parameter is used for reporting a measuring result by use of the second mode.

f) bit mapping length corresponding to the neighbor cell broadcast signaling (Nbr_Bitmap_Size); the IE is an optional IE and represents the bit number used during bit mapping when the neighbor cell base station is represented by use of the bit mapping mode of the NBR-ADV signaling.

g) bit mapping index corresponding to the neighbor cell broadcast signaling (Nbr_Bitmap_Index); the IE is an optional IE and represents the index number of the neighbor cell base station involved in the signaling when the neighbor cell base station is represented by use of the bit mapping mode of the NBR-ADV signaling. True is adopted and false is not adopted, which is indicated by use of one bit; true may be represented by use of 0 or 1, which is required to be preassigned. Setting a bit as true represents the signaling carries the associated measuring result of the base station corresponding to the bit.

h) base station type (BS type) including: Macro cell, Micro cell, Femto cell and Relay station; the bit number occupied by the base station type may be set according to the requirement of practical application. No matter which mode is used to report a measuring result, the base station type to which the base station belongs corresponding to each base station should be given. This information is not the necessary information in a location response signaling.

i) base station index number of neighbor base station (referred to as Neighbor_BS_Index), which is the base station index number of neighbor base station in the NBR-ADV and typically represented by use of eight bits. The IE is an optional IE; the index number of the base stations evolved in the measuring result should be given one by one when the measuring result is reported by use of the above second mode; the index number is identical to the base station index number of the NBR-ADV.

j) location request sequence ID (Req_Seq_Num), the IE is an optional IE and should be carried in the location response signaling when the location request signaling corresponding to the location response signaling includes a location response request ID. After receiving the location response signaling, the BS may compare the location request sequence ID of the location response signaling with the request sequence ID stored in the BS; if the location request sequence ID of the location response signaling is not identical to the request sequence ID stored in the BS, the BS discards the location report signaling.

k) bit mapping length corresponding to the location request signaling (Req_Bitmap_Size); the IE represents the bit length of the bit mapping when the measuring result is reported by use of the above third bit mapping mode.

l) bit mapping index corresponding to the location request signaling (Req_Bitmap_Index); the IE represents the index number of the neighbor cell base stations evolved in the signaling when the measuring result is reported by use of the above third bit mapping mode. true is adopted and false is not adopted, which is indicated by use of one bit; true may be represented by use of 0 or 1, which is required to be preassigned. Setting a bit as true represents the signaling carries the associated measuring result of the base station corresponding to the bit.

m) carrier interference and noise ratio mean of neighbor base station (BS CINR mean) indicating that a mobile station measures the CINR of a designated neighbor base station. It is possible to measure the subcarrier of preamble of neighbor base station and to get the mean within the measuring period.

n) receiving signal strength indication mean of neighbor base station (BS RSSI mean), which is a measuring result and is reported according to the requirement of the neighbor base station necessary for reporting the parameter.

o) relative delay, which is a measuring result and is reported according to the requirement of the neighbor base station necessary for reporting the parameter.

p) round-trip delay of serving base station (RTD), which is a measuring result; the RTD may be reported if it is necessary for reporting the parameter.

q) configuration change count value (referred to as Configuration change count for NBR-ADV); the IE is an optional IE and is used for representing the NBR-ADV signaling referenced when the signaling is set to compress the bits occupied by the ID code of neighbor base stations. The configuration change count value is identical to that of the corresponding location response signaling.

The IE included in the LBS-RSP provided by the present invention is as shown in Table 5.

TABLE 5

| Syntax | Other |
|---|---|
| Response Mode | Location response mode, including: per-request response, |
| | periodic response and event-triggered response |
| Use_Nbr_Bitmap_Index | indicating whether the bit mapping uses the base station |
| | index bit mapping of the NBR-ADV broadcast signaling. |
| Use_Req_Bitmap_Index | indicating whether the bit mapping uses the base station |
| | index bit mapping of the LBS-REQ signaling. |
| Response metric | Response parameters such as carrier interference and |
| | noise ratio mean of neighbor base station (BS CINR |
| | mean), receiving signal strength indication mean of |
| | neighbor base station (BS RSSI mean), relative delay, the |
| | round-trip delay of serving base station (BS RTD). |
| N_Neighbor_BS_Index | The number of neighbor base station index |
| Configuration change count for | the count value may be set with reference to the |
| NBR-ADV | corresponding count value in the NBR-ADV signaling |
| | and may be used for representing the NBR-ADV |
| | signaling referenced when the signaling is set |
| Nbr_Bitmap_Size | The bit length of bit mapping of neighbor base stations |
| Nbr_Bitmap_Index | The index of bit mapping of neighbor base station |
| BS type | Base station type (e.g. Macro cell; Micro cell; Femto cell |
| | (home cell); Relay station) |
| BS CINR mean | The carrier interference and noise ratio mean of neighbor |
| | base station |
| Relative delay | The relative delay |
| BS RSSI mean | The receiving signal strength indication mean of |
| | neighbor base station |
| Neighbor_BS_Index | The neighbor base station index |
| Req_Seq_Num | The location request ID |
| Req_Bitmap_size | The bit length of bit mapping of the location request |
| | signal |
| Req_Bitmap_Index | The index of bit mapping of the location request signal |
| BS RTD | the round-trip delay of serving base station |

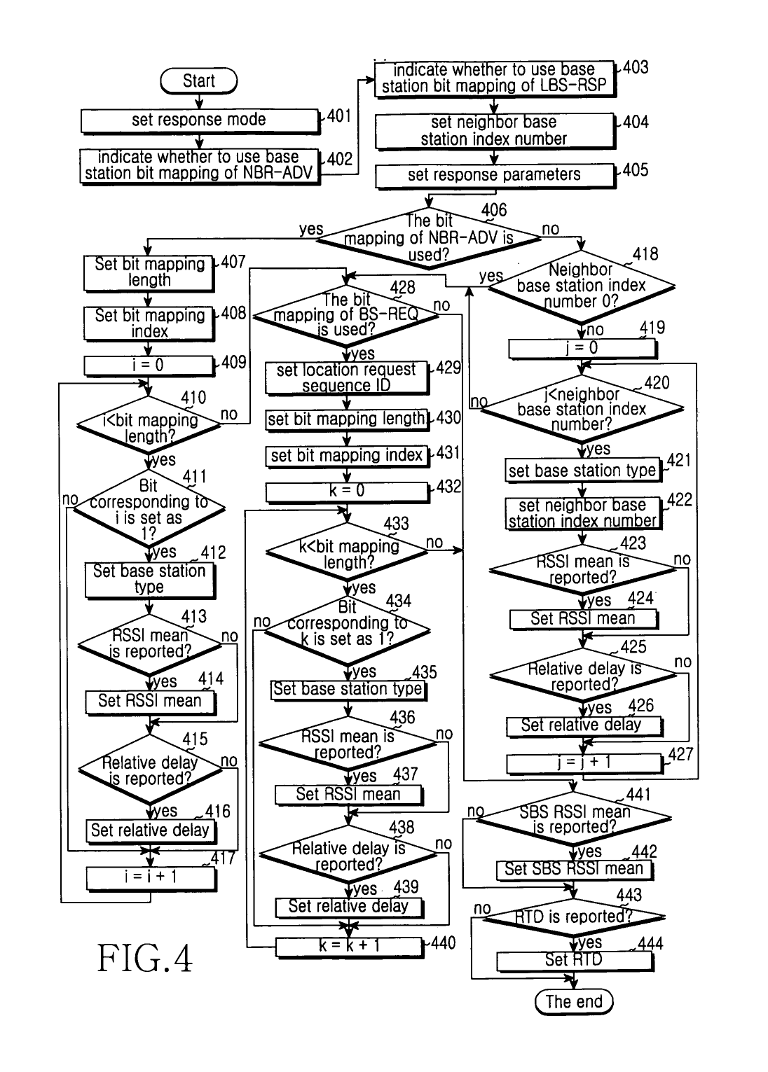

Based on the above description of the information included by the location response signaling of the present invention, the IE setting procedure of the location response signaling of the present invention may be hereinafter described with reference to the procedure as shown in FIG. 4. In this example, the description is given by taking the procedure for adapting the above three modes for reporting a measuring result in the same LBS-RSP signaling at the same time for example. As shown in FIG. 4, the IE setting procedure includes:

Block 401: setting a response mode.

Block 402: indicating whether to use the base station index bit mapping of the NBR-ADV.

Block 403: indicating whether to use the base station index bit mapping of the LBS-REQ.

Block 404: setting the index number of neighbor base stations. The value should be set when a measuring result is reported by use of the second mode.

Block 405: setting a response parameter.

The response parameter may be set by use of the bit mapping mode. Since the parameters that can be reported include: BS CINR Mean, BS RSSI mean, relative delay and RTD, preferably, the bit mapping may be performed by use of four bits.

In the following blocks 406-417, the measuring result is reported in the location response signaling by use of the above first mode.

Block 406: determining whether to use the base station index bit mapping of the NBR-ADV; if the base station index bit mapping of the NBR-ADV is used, performing block 407; otherwise, performing block 418.

Block 407: setting a bit mapping length corresponding to the NBR-ADV.

Block 408: representing the base station index by use of the bit mapping mode corresponding to the NBR-ADV.

Block 409: initializing a count variable i, and setting i=0.

Block 410: determining whether i is less than the bit mapping length corresponding to the NBR-ADV, if i is less than the bit mapping length corresponding to the NBR-ADV, performing block 411; otherwise, performing block 428.

Block 411: determining whether the bit in the bit mapping corresponding to the current value of i is set as 1, if the bit in the bit mapping corresponding to the current value of i is set as 1, performing block 412; otherwise, performing block 417.

Block 412: setting a base station type according to the base station corresponding to the current value of i.

Block 413: determining whether the RSSI mean of the base station corresponding to the current value of i should be reported, if the RSSI mean of the base station corresponding to the current value of i should be reported, performing block 414; otherwise, performing block 415.

Block 414: setting a RSSI mean according to the measured RSSI mean of the base station corresponding to the current value of i, and performing block 417.

Block 415: determining whether the relative delay of the base station corresponding to the current value of i should be reported, if the relative delay of the base station corresponding to the current value of i should be reported, performing block 416; otherwise, performing block 417.

Block 416: setting a relative delay according to the measured relative delay of the base station corresponding to the current value of i.

In a practical application, this procedure may be extended to add a step for determining whether the CINR mean of the base station corresponding to the current value of i should be reported; if the CINR mean of the base station corresponding to the current value of i should be reported, setting the corresponding CINR mean. For clarity of illustration, the above step is not shown in this flowchart.

Block 417: adding one to i, and returning to block 410.

In the following blocks 418-427, the measuring result is reported in the location response signaling by use of the above second mode.

Block 418: determining whether the set index number of neighbor base stations is equal to 0, if the set index number of neighbor base stations is not equal to 0, performing block 419; otherwise, performing block 428.

Block 419: initializing a count variable j, and setting j=0.

Block 420: determining whether j is less than the index number of neighbor base stations, if j is less than the index number of neighbor base stations, performing block 421; otherwise, performing block 428.

Block 421: setting a base station type.

Block 422: setting a base station index number of neighbor base station; the base station index number is identical to the base station index Table of the NBR-ADV.

Block 423: determining whether the RSSI mean of the current base station should be reported, if the RSSI mean of the current base station should be reported, performing block 424; otherwise, performing block 425.

Block 424: setting a RSSI mean according to the measured RSSI mean of the current base station.

Block 425: determining whether the relative delay of the current base station should be reported, if the relative delay of the current base station should be reported, performing block 426; otherwise, performing block 427.

Block 426: setting a relative delay according to the measured relative delay of the current base station.

Block 427: adding one to j, and returning to block 420.

In a practical application, this procedure may be extended to add the step for determining whether the CINR mean of the base station corresponding to the current value of i should be reported; if the CINR mean of the base station corresponding to the current value of i should be reported, setting the corresponding CINR mean. For clarity of illustration, the above step is not shown in this flowchart.

In the following blocks 428-440, the measuring result is reported in the location response signaling by use of the above third mode.

Block 428: determining whether to use the base station index bit mapping of the LBS-REQ; if the base station index bit mapping of the LBS-REQ is used, performing block 429; otherwise, performing block 441.

Block 429: setting a location request sequence ID.

Block 430: setting a bit mapping length corresponding to the LBS-REQ.

Block 431: representing the base station index by use of the bit mapping mode corresponding to the LBS-REQ.

Block 432: initializing a count variable k, and setting k=0.

Block 433: determining whether k is less than the bit mapping length corresponding to the LBS-REQ, if k is less than the bit mapping length corresponding to the LBS-REQ, performing block 434; otherwise, performing block 441.

Block 434: determining whether the bit in the bit mapping corresponding to the current value of k is set as 1, if the bit in the bit mapping corresponding to the current value of k is set as 1, performing block 435; otherwise, performing block 440.

Block 435: setting a base station type according to the base station corresponding to the current value of k.

Block 436: determining whether the RSSI mean of the base station corresponding to the current value of k should be reported, if the RSSI mean of the base station corresponding to the current value of k should be reported, performing block 437; otherwise, performing block 438.

Block 437: setting a RSSI mean according to the measured RSSI mean of the base station corresponding to the current value of k.

Block 438: determining whether the relative delay of the base station corresponding to the current value of k should be reported, if the relative delay of the base station corresponding to the current value of k should be reported, performing block 439; otherwise, performing block 440.

Block 439: setting a relative delay according to the measured relative delay of the base station corresponding to the current value of k.

In a practical application, this procedure may be extended to add the step for determining whether the CINR mean of the base station corresponding to the current value of i should be reported; if the CINR mean of the base station corresponding to the current value of i should be reported, setting the corresponding CINR mean. For clarity of illustration, the above step is not shown in this flowchart.

Block 440: adding one to k, and returning to block 433.

Block 441: determining whether the RSSI mean of the serving base station should be reported, if the RSSI mean of the serving base station should be reported, performing block 442; otherwise, performing block 443.

Block 442: setting a RSSI mean according to the measured RSSI mean of the serving base station.

Block 443: determining whether the RTD of the serving base station should be reported, if the RTD of the serving base station should be reported, performing block 444; otherwise, terminating the procedure.

Block 444: setting a RTD according to the measured RTD of the serving base station.

Then, the IE setting procedure of location response signaling of the present invention is terminated.

Based on the above signals provided by the present invention, the location may be triggered by an MS or a base station when the MS is in connection state. Besides, the detailed location calculation may be performed by the MS or the network side. The applications of the above signals are hereinafter described in detail with reference to several detailed signaling procedures.

### Embodiment 1

This embodiment is described by taking the DL-TDOA triggered by an MS and performed the location management by the MS for example.

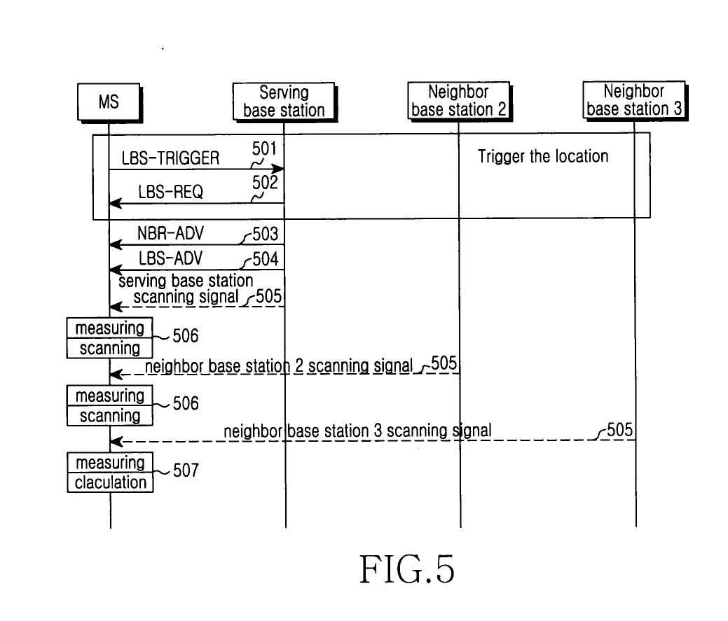

FIG. 5 is a signaling flowchart illustrating the downlink location method according an embodiment of the present invention. Referring to FIG. 5, the entities involved in the location procedure include: an MS, a serving base station, a neighbor base station 2 and a neighbor base station 3. The location procedure includes the following:

Block 501: the MS sends to the serving base station a location trigger signaling (LBS-TRIGGER) for requiring a downlink location.

In block 501, the type of the method for performing the downlink location may be designated in the sent LBS-TRIGGER, e.g. DL-TDOA, and other associated information may be carried in the LBS-TRIGGER according to the above described content of the present invention.

Block 502: the serving base station sends a location request signaling (LBS-REQ) to the MS.

As it is described above, the location request signaling may be used for a base station directly triggering the location, or may also be used for responding to the LBS-TRIGGER sent by an MS. When it is not supported in the system that an MS triggering the location (i.e., the MAC layer does not support the MS triggering mode), the procedure is directly started from Block 502.

In the LBS-REQ, the base station should notify the MS of the type of scanning signal and the index number, the response period, the reporting mode and the response parameter, so that the MS may perform the measuring and the scanning, and may report a measuring result as required.

Block 503 and block 504: after receiving the LBS-REQ, the MS continues to receive a NBR-ADV and a LBS-ADV sent by the serving base station.

Block 505: the serving base station, neighbor base station 2 and neighbor base station 3 send a scanning signal respectively.

Block 506: the MS measures and scans the signals sent by the serving base station, neighbor base station 2 and neighbor base station 3.

In this step, the MS may measure the relative delay between the serving base station and the neighbor base stations, the RSSI of the serving base station and the neighbor base stations, and the CINR of the neighbor base stations.

Block 507: the MS performs the location calculation according to the measured parameters.

Then, this location procedure is terminated.

### Embodiment 2

The embodiment is described by taking the DL-TDOA performed the location management by the network side for example.

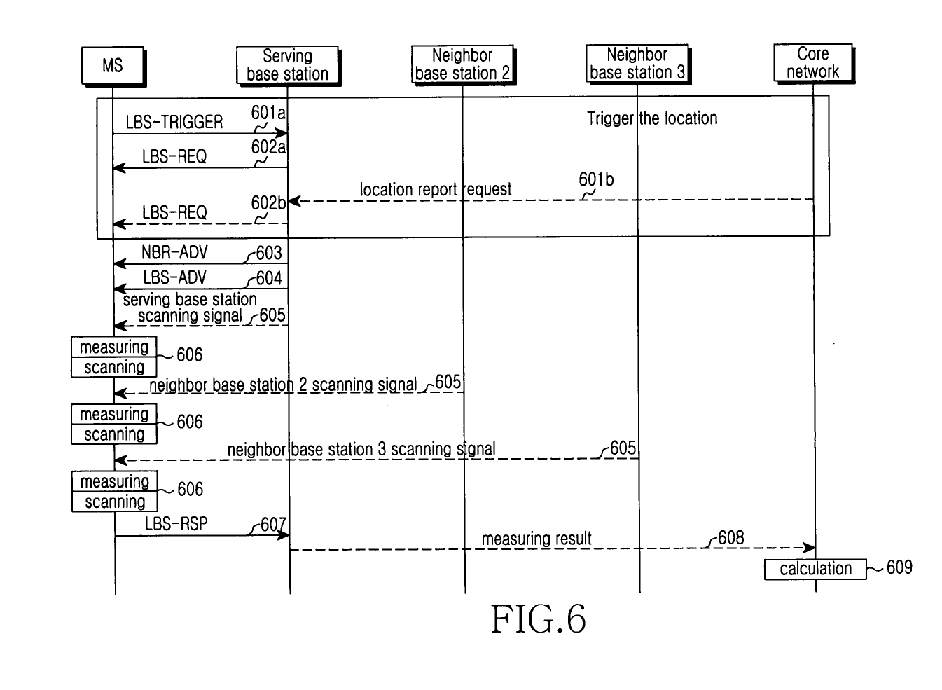

FIG. 6 illustrates signaling for the downlink location method according to an embodiment of the present invention; Referring to FIG. 6, the entities involved in the location procedure include: an MS, a serving base station, a neighbor base station 2, a neighbor base station 3 and a core network/location system. The location procedure may be triggered by the MS (corresponding to blocks 601a and 602a of FIG. 6), or may also be triggered by the network side (corresponding to block 601b and 602b of FIG. 6). The location procedure as shown in FIG. 6 includes the following:

Block 601a: the MS sends to the serving base station a location trigger signaling (LBS-TRIGGER) for requiring a downlink location.

In block 601, the type of the method for performing the downlink location may be designated in the sent LBS-TRIGGER, e.g. DL-TDOA, and other associated information may be carried in the LBS-TRIGGER according to the above described content of the present invention.

Block 602a: after receiving the LBS-TRIGGER, the serving base station sends a location request signaling (LBS-REQ) corresponding to the LBS-TRIGGER.

In the LBS-REQ, the base station should notify the MS of the type of scanning signal and the index number, the response period, the reporting mode and the response parameter, so that the MS may perform the measuring and the scanning, and may report a measuring result as required.

In this embodiment, for the following the type of scanning signal set in the LBS-REQ signaling is reference signal.

Block 601b: the core network sends to the serving base station a location report request (location report REQ) signaling for requesting the location of MS.

Block 602b: the serving base station sends to the MS a LBS-REQ signaling for triggering the location.

In the LBS-REQ, the base station notifies the MS that the location method is DL-TDOA, and notifies the MS of the type of scanning signal, the index number, the response period, the reporting mode and the response parameter, so that the MS may perform the measuring and the scanning, and may report a measuring result as required.

In this embodiment, supposing that the type of scanning signal set in the LBS-REQ signaling is reference signal; of course, it may also be set as preamble in a practical application.

The above two triggering modes may both be used to trigger the location, and one of them may be used.

Block 603 and block 604: after receiving the LBS-REQ, the MS continues to receive a NBR-ADV and a LBS-ADV sent by the serving base station.

Block 605: the serving base station, neighbor base station 2 and neighbor base station 3 send a reference signal respectively. If the type of scanning signal set in the LBS-REQ signaling in block 602b is the preamble, in this step, the serving base station, neighbor base station 2 and neighbor base station 3 may also send a preamble respectively.

Block 606: the MS measures and scans the reference signals sent by the serving base station, neighbor base station 2 and neighbor base station 3.

In this step, the MS may measure the relative delay between the serving base station and the neighbor base stations, the RSSI of the serving base station and the neighbor base stations, and the CINR of the neighbor base stations.

Block 607: the MS reports a measuring result to the serving base station by a LBS-RSP.

Block 608: the serving base station sends to the core network the measuring result reported by the MS.

Block 609: the location server of the core network performs the location calculation according to the measuring result.

Then, the location procedure of embodiment 2 of the present invention is terminated. When it is not supported in the system that an MS triggering the location (i.e. the MAC layer does not support the MS triggering mode), the system performs blocks 601b-602b and blocks 603-608.

### Embodiment 3

The embodiment is described by taking the UL-TDOA performed the location management by the network side for example. In this embodiment, the MS sends a ranging signal; various base stations participating in the location receive the ranging signal for measuring at the same time, and feed back the location measuring result of various base stations to the location server for performing the location calculation.

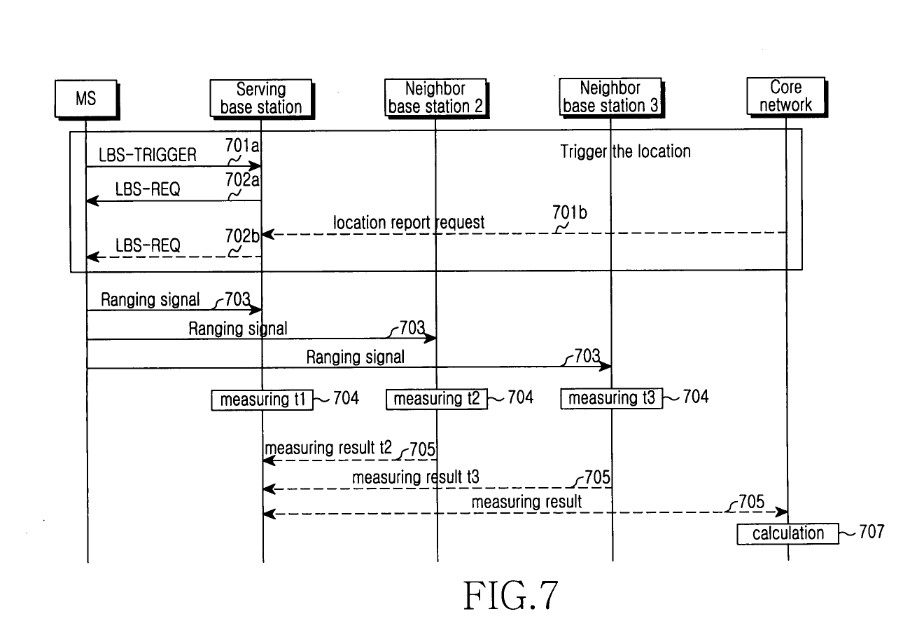

FIG. 7 illustrates signaling for the uplink location method according to this embodiment of the present invention. Referring to FIG. 7, the entities involved in the location procedure include: an MS, a serving base station, a neighbor base station 2, a neighbor base station 3 and a core network/location system. Similar to embodiment 2, the location procedure may be triggered by the MS (corresponding to blocks 701a and 702a of FIG. 7), or may also be triggered by the network side (corresponding to blocks 701b and 702b of FIG. 7). The location procedure as shown in FIG. 7 includes the following:

Block 701a: the MS sends to the serving base station a location trigger signaling (LBS-TRIGGER) for requiring an uplink location.

In block 701a, the type of the method for performing the uplink location may be designated in the sent LBS-TRIGGER, e.g. UL-TDOA, and other associated information may be carried in the LBS-TRIGGER according to the above described content of the present invention.

Block 702a: after receiving the LBS-TRIGGER, the serving base station sends a location request signaling (LBS-REQ) corresponding to the LBS-TRIGGER.

In the LBS-REQ signaling, the base station should notify the MS of the type of scanning signal and the index number; since this embodiment is an uplink location performed the location calculation by the network side, the MS does not require to report a measuring report to the base station; that is to say, it is unnecessary for the base station to indicate the information of reported measuring result such as the response period, the reporting mode and the response parameter in the LBS-REQ signaling.

In block 702a, the base station may indicate that the type of scanning signal is a Ranging signal in the LBS-REQ signaling, and may notify the MS of the index number of the Ranging signal; at the same time, it is required to notify the MS of sending a signal rendezvous time and a transmission opportunity offset of the Ranging signal after receiving the LBS-REQ signaling, so that the MS may send the corresponding Ranging signal at the proper time according to these parameters.

Block 701b: the core network sends to the serving base station a location report request (location report REQ) signaling for requesting the location of MS.

Block 702b: the serving base station sends to the MS a LBS-REQ signaling for triggering the location.

In the LBS-REQ, the serving base station notifies the MS that the location method is UL-TDOA, and notifies the MS of other contents included in the LBS-REQ signaling in block 702a, which is not described in detail herein.

Block 703: the MS sends a Ranging signal.

In block 703, the MS may acquire three parameters of Ranging signal, including signal rendezvous time, Ranging code and transmission opportunity offset, assigned by the serving base station according to the received LBS-REQ, and may send a Ranging signal according to these parameters.

Block 704: the serving base station, neighbor base station 2 and neighbor base station 3 perform the measuring at the same time respectively.

Block 705: neighbor base station 2 and neighbor base station 3 send the measuring results to the serving base station.

Block 706: the serving base station sends to the core network the measuring results of the serving base station, neighbor base station 2 and neighbor base station 3.

Block 707: the location server of the core network performs the location calculation according to the measuring results.

Then, the location procedure of embodiment 3 of the present invention is terminated. When it is not supported in the system that an MS triggering the location (i.e., the MAC layer does not support the MS triggering mode), the system performs blocks 701b-702b and blocks 703-707.

### Embodiment 4

The embodiment is described by taking the UL-TDOA performed the location calculation by the network side for example. In this embodiment, the MS sends the different ranging signals at the different time preassigned by the serving base station; various base stations participating in the location measure the corresponding ranging signals respectively, and send the location measuring results of various base stations to the location server for performing the location calculation.

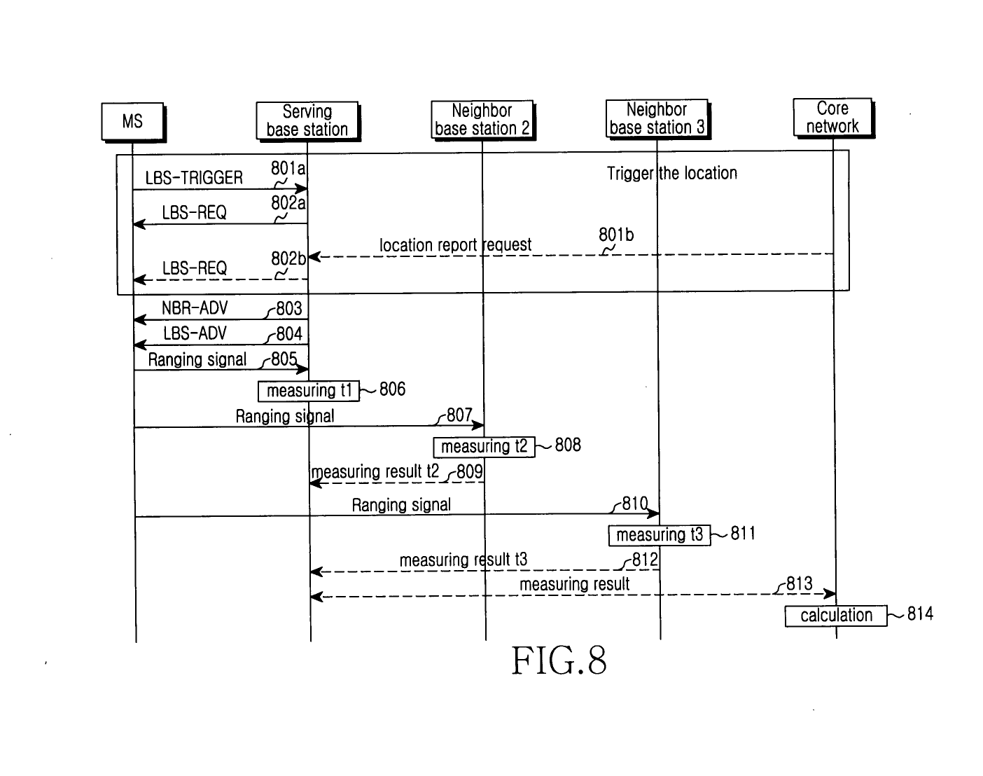

FIG. 8 illustrates signaling for the uplink location method according to this embodiment of the present invention. Referring to FIG. 8, the entities involved in the location procedure include: an MS, a serving base station, a neighbor base station 2, a neighbor base station 3 and a core network/location system. Similar to embodiment 3, the location procedure may be triggered by the MS (corresponding to blocks 801a and 802a of FIG. 8), or may also be triggered by the network side (corresponding to blocks 801b and 802b of FIG. 8). The location procedure as shown in FIG. 8 includes the following:

Block 801a: the MS sends to the serving base station a location request signaling (LBS-TRIGGER) for requiring an uplink location.

In block 801a, the type of the method for performing the uplink location may be designated in the sent LBS-TRIGGER, e.g. UL-TDOA, and other associated information may be carried in the LBS-TRIGGER according to the above described content of the present invention.

Block 802a: after receiving the LBS-TRIGGER, the serving base station sends a location request signaling (LBS-REQ) corresponding to the LBS-TRIGGER.

Similar to block 702a, in the LBS-REQ signaling, the base station should notify the MS of the type of scanning signal and the index number; since this embodiment is an uplink location performed the location calculation by the network side, the MS does not require to report a measuring report to the base station; that is to say, it is unnecessary for the base station to indicate the information of the response period, the reporting mode and the response parameter in the LBS-REQ signaling.

Since the MS sends the different ranging signals at the different time and various base stations participating in the location measure the corresponding ranging signals at the corresponding time in this embodiment, the base station may indicate that the type of scanning signal is a Ranging signal in the LBS-REQ, and may notify various base stations participating in the location of the index number of the Ranging signal; at the same time, it is required to notify the MS of sending a signal rendezvous time and a transmission opportunity offset of the Ranging signal after receiving the LBS-REQ signaling, so that the MS may send a Ranging signal.

Block 801b: the core network sends to the serving base station a location report request (location report REQ) signaling for requesting the location of MS.

Block 802b: the serving base station sends to the MS a LBS-REQ signaling for triggering the location.

In the LBS-REQ, the serving base station notifies the MS that the location method is UL-TDOA, and notifies the MS of other contents included in the LBS-REQ signaling in block 802a, which is not described in detail herein.

Block 803 and block 804: after receiving the LBS-REQ, the MS continues to receive a NBR-ADV and a LBS-ADV sent by the serving base station.

The MS may determine the base stations participating in the location and the Ranging signal adopted for each base station according to the index number of the base stations participating in the location and the index number of scanning signal determined by means of the LBS-REQ in connection with the NBR-ADV and the LBS-ADV.

Block 805: the MS determines the Ranging signal sent to the serving base station and the time for sending the Ranging signal according to the LBS-REQ, and sends the Ranging signal at the corresponding time.

Block 806: the serving base station performs the measuring according to the Ranging signal sent by the MS.

Block 807: the MS determines the Ranging signal sent to neighbor base station 2 and the time for sending the Ranging signal according to the LBS-REQ, and sends the Ranging signal at the corresponding time.

Block 808: neighbor base station 2 performs the measuring according to the Ranging signal sent by the MS.

Block 809: neighbor base station 2 sends the measuring results to the serving base station.

Block 810: the MS determines the Ranging signal sent to neighbor base station 3 and the time for sending the Ranging signal according to the LBS-REQ, and sends the Ranging signal at the corresponding time.

Block 811: neighbor base station 3 performs the measuring according to the Ranging signal sent by the MS.

Block 812: neighbor base station 3 sends the measuring results to the serving base station.

Block 813: the serving base station sends to the core network the measuring results of the serving base station, neighbor base station 2 and neighbor base station 3.

Block 814: the location server of the core network performs the location calculation according to the measuring results.

Then, the location procedure of embodiment 4 of the present invention is terminated. When it is not supported in the system that an MS triggering the location (i.e., the MAC layer does not support the MS triggering mode), the system performs blocks 801b-802b and blocks 803-814.

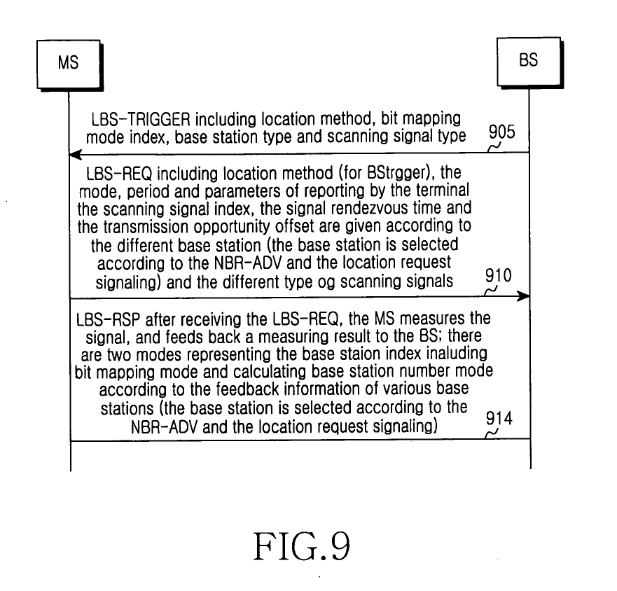

In FIG. 9, the interaction among the LBS-TRIGGER signaling, the LBS-REQ signaling and the LBS-RSP signaling and the interaction information among them in accordance with the present invention are described in detail. Preferably, wherein:

the location trigger signaling 905 is used for a terminal initiating a location request; the terminal may select the different location method according to the different scenes, and may recommend the information of the neighbor base stations participating in the location;

the location request signaling 910 has two responsibilities: the first one is to respond to the location trigger signaling sent by a terminal; the second one is to finish the location request initiated by the network side; the location request signaling mainly includes the index, the signal rendezvous time and the transmission opportunity offset of scanning signal; and

there are three modes for reporting a measuring result including measuring parameters in the location response signaling 910, including: the first part is to report a measuring result by use of the bit mapping mode according to the base station information of the neighbor base station information broadcast signaling; the second part is to report a measuring result by use of the count mode according to the base station index of the neighbor base station information broadcast signaling; the third part is to report a measuring result according to the base station represented by the bit mapping mode of the location request signaling.

The above four signals are signals for performing the location when an MS is in connection state in accordance with the present invention. In fact, there is also a location requirement when an MS is in idle state. The present invention provides a method for supporting the location service during page when an MS is in idle state.

When an MS is in idle state, if a base station requires page the MS, it is necessary for sending a page broadcast (PAG-ADV) signaling. In the present invention, by adding a location service indication element and a location method indication element in the PAG-ADV signaling, it is possible to indicate the MS of the location service and the location method; in this way, after connecting into the network, the MS may rapidly perform the location operation in coordination with the base station, which reduces the overhead of interaction signals. The content of location service that should be added in the PAG-ADV signaling of the present invention is as shown in Table 6.

TABLE 6

| Syntax | Other |
|---|---|
| Num_MACs | The total number of MAC addresses of the |
| | MS in this page |
| For (j = 0; j < | — |
| Num_MACs; j++) { | |
| MS MAC Address hash | The hash value computed by use of the |
| | MAC addresses of the terminal |
| Action Code | 0b00: performing network re-entry |
| | 0b01: performing the Ranging for the |
| | location |
| | 0b10: perform the LBS measuring |
| If (Action Code==0b10){ | — |
| Location method_type | Location method type |
| | 0b000: CellID |
| | 0b001: D-TDOA |
| | 0b010: U-TDOA |
| | 0b100: switching between TDOA and |
| | TOA |
| | (the bit may randomly correspond to the |
| | meaning, which is only an example) |
| } | |
| } | |

In the present invention, two contents are added in the PAG-ADV signaling.

a) action code for indicating whether to perform the location. The action code may be represented by one bit or multiple bits; when the action code is represented by one bit, performing the location service measuring may be represented by “0b0” or “0b1”; when the action code is represented by multiple bits, which bit value of multiple bits representing performing the location service measuring may be set. According to the set representing mode, when the value of action code is set as performing the location service measuring, the MS may determine that the objective of the MS currently sending a page is to perform the location service.

b) location method for determining to use which location method. To determine a location method, it is possible to configure a signaling more flexibly and reduce the overhead of interaction signaling. The type of location method and the representing mode of location method in the signaling are described above in detail, which is not described in detail herein.

The signaling interaction procedure when the location is performed by use of the above extended PAG-ADV signaling of the present invention is simply described hereinafter by taking the location method based on Cell ID, DL-TDOA and UL-TDOA for example respectively.

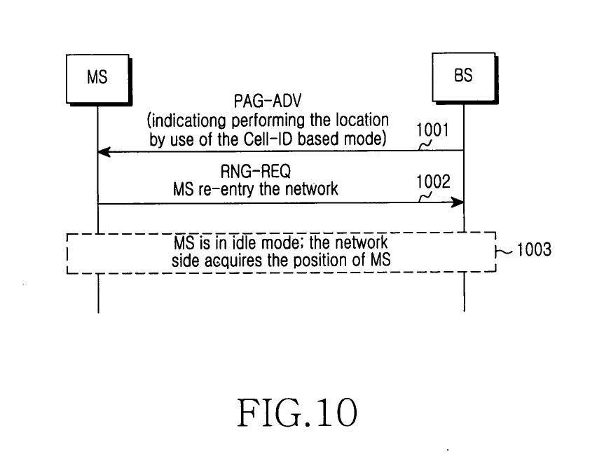

FIG. 10 illustrates a process for performing the location based on the Cell-ID when an MS is in idle state. As shown in FIG. 10, the signaling procedure comprises the following:

Block 1001: a BS sends a page broadcast signaling carrying the location service indication and the indication for performing the location by use of the Cell-ID method.

Block 1002: after receiving the page broadcast signaling, the MS sends to the destination BS a ranging request signaling (RNG-REQ), and finishes the re-entry by a series of signaling interaction with the destination BS.

Block 1003: after the MS finishes the re-entry, the network side acquires which BS that is accessed by the MS, and determines which cell in which the MS resides, so that the position of MS is determined.

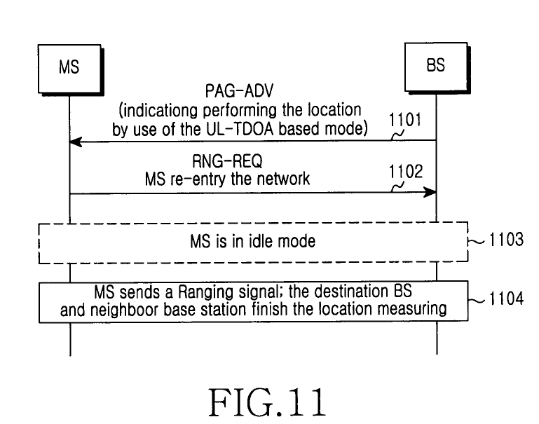

FIG. 11 illustrates a process for performing the location based on the UL-TDOA when an MS is in idle state. As shown in FIG. 11, the signaling procedure comprises the following:

Block 1101: the BS sends a page broadcast signaling carrying the location service indication and the indication for performing the location by use of the UL-TDOA method.

Block 1102: after receiving the page broadcast signaling, the MS sends to the destination BS a ranging request signaling (RNG-REQ), and finishes the re-entry by a series of signaling interaction with the destination BS.

Block 1103: after finishing the re-entry, the MS is in idle mode.

Block 1104: the destination BS assign a Ranging channel and a Ranging channel of neighbor base station to the MS; the MS sends Ranging signals to the destination BS and neighbor base stations respectively; the destination BS and neighbor base stations finish the location measuring.

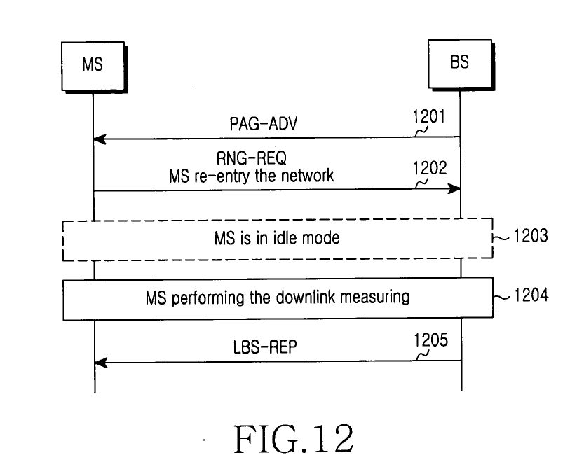

FIG. 12 illustrates a process for performing the location based on the DL-TDOA when an MS is in idle state. As shown in FIG. 12, the signaling procedure comprises the following steps.

Block 1201: the BS sends a page broadcast signaling carrying the location service indication and the indication for performing the location by use of the DL-TDOA method.

In Block 1201, the BS may also indicate to use the switching method of DL-TDOA and TOA for performing the location in the page broadcast signaling.

Block 1202: after receiving the page broadcast signaling, the MS sends to the destination BS a ranging request signaling (RNG-REQ), and finishes the re-entry by a series of signaling interaction with the destination BS.

Block 1203: after finishing the re-entry, the MS is in idle mode.

Block 1204: after receiving a NBR-ADV signaling, the MS acquires the sequence number of preamble of neighbor bas stations, and performs the downlink measuring based on the time difference of preamble.

Block 1205: the MS sends a measuring result to the destination base station by a LBS-REP signaling.

If the method based on the switching between the DL-TDOA and the TOA is used, in this step, the MS further requires to report the RSSI and the RTD of BS.

Considering the location capability may be negotiated between the base station and the MS, the network side requires determining that the MS has which location capability, and triggers the different location modes according to the practical situations. Therefore, the corresponding signaling and the detailed negotiation procedure are provided by the present invention, which is hereinafter described in detail.

The IE included in the location capability negotiation request (LBS-CONF_REQ) signaling is as shown in Table 7.

TABLE 7

| Syntax | Other |
|---|---|
| LBS capability type REQ | Location capability type request |

The LBS-CONF_REQ signaling provided by the present invention is used for a BS requesting to acquire the location capability supported by an MS from the MS; the signaling only includes a location capability type request indication element of one bit representing requiring the MS to feed back the location capability that can be supported by the MS.

The IE included in the location capability negotiation response (LBS-CONF_RSP) signaling is as shown in Table 8.

TABLE 8

| Syntax | Other |
|---|---|
| LBS capability type bitmap index | The bit mapping of location |
| | capability type |

The LBS-CONF_RSP signaling provided by the present invention is used for an MS feeding back the location capability that can be supported by the MS to the BS. The signaling may also only includes one IE of the bit mapping of location capability type (LBS capability type bitmap index). According to the capability that can be supported by the current MS, the value of the IE may include:

a) GPS supported for representing the MS supporting independent GPS location capability without any help of the network side;

b) A-GPS supported for representing the MS has a GPS location capability that should be assisted by the network.

c) Non-GPS supported for representing the MS may perform the location only in coordination with the network without the help of GPS;

d) representing the MS may support the location in the emergency case.

However, the above currently-supported location capability is not limited in the practical application. When it is necessary to add a location capability, it is only required to add the corresponding bit mapping.

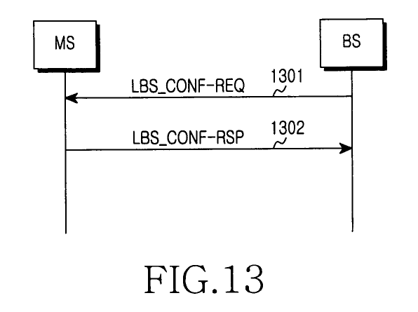

FIG. 13 illustrates a process for negotiating the location capability in accordance with the present invention. As shown in FIG. 13, the signaling procedure comprises the following:

Block 1301: the BS sends to an MS a location capability negotiating request signaling (LBS-CONF_REQ).

Block 1302: the MS feeds back a location capability negotiating response signaling (LBS-CONF_RSP) to the BS according to its location capability.

To implement the location capability negotiation between an MS and a BS, the present invention further provides a method for supporting the location capability negotiation by adding an IE indication element in the existing protocol. At present, two signals exist in the existing protocol including system basic capability request (SBC-REQ) signal or registration request (REG-REQ) signal and system basic capability response (SBC-RSP) signal or registration response (REG-RSP) signal; the main function of them is to perform the pre-authenticated capability negotiation between a mobile station and a base station when the mobile station accesses the network. Therefore, the location capability negotiation may be implemented by carring the corresponding indication elements in the existing two signals of SBC-REQ/REG-REQ and SBC-RSP/REG-RSP.

The IE as shown in Table 9 is added in the SBC-REQ/REG-RSP signal in accordance with the present invention, so that the base station clarify whether the mobile station supports the location capability of A-GPS, or the base station clarify which location capability that can be supported by the mobile station.

TABLE 9

| Syntax | Other | signaling |
|---|---|---|
| Capability for | capability for supporting A-GPS | SBC-REQ/ |
| supporting AGPS | 0b0: not support AGPS | REG-REQ |
| | 0b1: support AGPS | |
| Capability for supporting | The supported location | SBC-REQ/ |
| LBS capability type | capability | REG-REQ |

In Table 9, the capability for support A-GPS (referred to as Capability for support AGPS) is used for representing whether the mobile station support the location capability of A-GPS. It may be represented by one bit; it is negotiated that setting the bit as 0 represents not support and setting the bit as 1 represents support; alternatively, it is negotiated that setting the bit as 1 represents not support and setting the bit as 0 represents support. of course, it may also be represented by multiple bits.

In Table 9, location capability type (referred to as Capability for support LBS capability type) is used for representing the location capability that can be supported by an MS. According to the capability that can be supported by the current MS, the value of the IE may include:

a) GPS supported for representing the MS supporting independent GPS location capability without any help of the network side;

b) A-GPS supported for representing the MS has a GPS location capability that should be assisted by the network.

c) Non-GPS supported for representing the MS may perform the location only in coordination with the network without the help of GPS;

d) representing the MS may support the location in the emergency case.

However, the above currently-supported location capability is not limited in the practical application. When it is necessary to add a location capability, it is only required to add the corresponding bit mapping.

The IE as shown in Table 10 is added in the SBC-RSP/REG-RSP signaling in accordance with the present invention, so that the mobile station clarify whether the base station supports the location capability of A-GPS, or the mobile station clarify which location capability that can be supported by the base station.

TABLE 10

| Syntax | Other | Signaling |
|---|---|---|
| Capability for | capability for supporting A-GPS | SBC-RSP/ |
| supporting AGPS | 0b0: not support AGPS | REG-RSP |
| | 0b1: support AGPS | |
| Capability for supporting | The supported location capability | SBC-RSP/ |
| LBS capability type | | REG-RSP |

The meanings of two IEs of Table 10 are the same as that of Table 9; the different is only that, the IE of Table 10 represents the location capability of base station.

It can be seen from the above embodiments that, in the method of implementing the location in accordance with the present invention, the base stations participating in the location and the parameters required in the location are determined by the signaling interaction between a mobile station and a serving base station so as to clarify the method for use in the location; afterwards, the mobile station and the base stations participating in the location perform the location measuring according to the determined parameters required in the location to solve the problem that the feedback information of one side is impossible to reach the location requirement desired by the other side since the two sides of signaling are impossible to acquire the purpose of signaling completely in the prior art, and to solve the problem that the existing signaling can only support a single location method.

On the basis of the above technical solution, the mobile station and the serving base station provided by the present invention may further determine the location method via the signaling interaction; besides, the mobile station and the base stations participating in the location perform the location measurement according to the determined location method and the parameters required in the location. Since it may be determined to adopt any one or multiple existing location method in the prior art when the mobile station and the serving base station determine the location method, such as, the mixed location method, it is needless to perform the location based on the mixed location method supported by several sets of signaling in the prior art, it is possible to save the signaling overhead and reduce the delay, thereby improving the system efficiency and the throughput of the system available information.

In addition, in accordance with the present invention, by providing a set of signaling for use in performing the location, it is possible to solve the problem that the redundancy of existing signaling and the system overhead are large, so as to improve the throughput of the system available information. Besides, in accordance with the signaling and method provided by the present invention, it is possible to support the uplink and downlink location at the same time; each location method supports the mobile station triggering and the network triggering, which improves the flexibility of location triggering.

In accordance with the method of negotiating the location capability provided by the present invention, it is possible to negotiate the location capability between a base station and a mobile station, and the mobile station and the base station may trigger the different location methods according to the location capability supported by two sides.

The foregoing descriptions are only preferred embodiments of the present invention and are not for use in limiting the protection scope thereof. Any modification, equivalent replacement and improvement made under the spirit and principle of the present invention should be included in the protection scope thereof.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for implementing the location, the method comprising:
determining the information of the base stations participating in the location and parameters required in the location by the signaling interaction between a mobile station and a serving base station;
performing, by the mobile station and the base stations participating in the location, the location measuring according to the determined parameters required in the location; and
performing the location calculation according to the measuring results of location measuring.

2. The method of claim 1, wherein the location is triggered by the mobile station; the mobile station is in connection state; and determining comprises:
sending, by the mobile station, to the serving base station a location trigger signal carrying the information of the base stations participating in the location and the type of a scanning signal;
returning, by the serving base station, a location request signal to the mobile station after receiving the location trigger signal; the location request signal configured to carry the response mode indicating information, the information of the base stations participating in the location, the type of a scanning signal, a scanning signal and parameters required in the location corresponding to the scanning signal.

3. The method of claim 1, wherein the location is triggered by the serving base station; the mobile station is in connection state; and determining comprises: sending, by the serving base station, a location request signaling to the mobile station; the location request signaling carries the response mode indicating information, the information of the base stations participating in the location, the type of a scanning signal, a scanning signal and parameters required in the location corresponding to the scanning signal.

4. The method of claim 2, wherein determining further comprises: setting, by the serving base station, the response mode indicating information of the location request signaling as a response mode adopted for the mobile station reporting a measuring result, and carrying a response period and the response parameter information in the location request signaling; and
wherein the method further comprises: sending, by the mobile station, to the serving base station a location response signaling carrying a measuring result according to the response mode indicating information, the response period and the response parameter information of the location request signaling; sending, by the serving base station, the measuring result of the location response signaling to a location server; wherein performing the location calculation comprises: performing, by the location server, a location calculation according to the measuring result.

5. The method of claim 2, wherein the method further comprises: sending, by the serving base station, to the mobile station a location broadcast signaling carrying the position information of neighbor base stations; and wherein performing the location calculation comprises: performing, by the mobile station, a location calculation according to the measuring result and the position information of neighbor base stations in the location broadcast signaling.

6. The method of claim 2, wherein indication elements included in the location trigger signal comprise: a type of a location method, a recommended number of base stations, a bit mapping length corresponding to a neighbor cell broadcast signal, a bit mapping index corresponding to a neighbor cell broadcast signal, a type of base station and the type of scanning signal,
the type of location method is configured to represent an adopted location method;
the recommended number of base station is configured to represent a number of base stations participating in the location recommended by the mobile station;
the bit mapping length corresponding to a neighbor cell broadcast signaling is configured to represent the bit number used in the bit mapping when the information of the recommended base stations participating in the location is given by use of the bit mapping mode;
the bit mapping index corresponding to a neighbor cell broadcast signaling is configured to represent the index indication of neighbor base stations when the information of the recommended base stations participating in the location is given by use of the bit mapping mode;
the type of base station is configured to represent a type of neighbor base stations;
the type of scanning signal is configured to represent a type of a scanning signal; the scanning signal is used for measuring parameters required in the location.

7. The method of claim 2, wherein
indication elements included in the location trigger signal comprise: a type of a location method, a recommended number of base stations, the type of base station, a base station index number of neighbor base stations and the type of scanning signal,
the type of location method is configured to represent an adopted location method;
the recommended number of base station is configured to represent a number of the base stations participating in the location recommended by the mobile station;
the type of base station is configured to represent a type of neighbor base stations;
the base station index number of neighbor base stations is configured to represent a base station index number of neighbor base stations when the information of the recommended base stations participating in the location is given by use of the count mode;
the type of scanning signal is configured to represent the type of a scanning signal; the scanning signal is used for measuring parameters required in the location.

8. The method of claim 7, wherein
the location trigger signaling further comprises an indication element of configuration change count value for representing a neighbor cell broadcast signaling referenced when the signaling is set.

9. The method of claim 7, wherein
the location trigger signal further comprises an indication element of trigger sequence ID for marking each newly-constructed location trigger signal by the trigger sequence ID and storing the ID when the mobile station constructs the location trigger signal; after receiving the location request signal, the mobile station determines whether the trigger sequence ID of the location request signal is identical to the stored trigger sequence ID; if the trigger sequence ID of the location request signal is not identical to the stored trigger sequence ID, the location request signal is discarded.

10. The method of claim 4, wherein
indication elements included in the location request signal comprise: a type of a location method, a response mode indicating information, an indication for using the base station index bit mapping of neighbor cell broadcast signaling, a bit mapping length corresponding to a neighbor cell broadcast signal, a bit mapping index corresponding to a neighbor cell broadcast signal, the type of base station, a type of a scanning signal, a scanning signal and parameters required in the location corresponding to the scanning signal,
the type of location method is configured to represent an adopted location method;
the response mode indicating information is configured to indicate a mode for the mobile station reporting a measuring result; it is unnecessary for a mobile station to report a measuring result when the response mode indicating information indicates it is unnecessary to report a measuring result; when the response mode indicating information is set as the response mode adopted when the mobile station reports a measuring result, the location request signal further includes indication elements of a response period and response parameters;
a response period is configured to indicate the period for the serving base station suggesting the mobile station to report the response signaling before sending a next location request signal;
a response parameter is configured to indicate the measuring parameters that should be reported by the mobile station;
the indication for using the base station index bit mapping of neighbor cell broadcast signaling is configured to indicate whether to use the base station index bit mapping of the neighbor cell broadcast signaling;
the bit mapping length corresponding to a neighbor cell broadcast signaling is configured to represent the bit number used in the bit mapping when the information of the recommended base stations participating in the location is given by use of the bit mapping mode identical to the neighbor cell broadcast signaling;
the bit mapping index corresponding to a neighbor cell broadcast signaling is configured to represent the index indication of neighbor base stations when the information of the recommended base stations participating in the location is given by use of the bit mapping mode identical to the neighbor cell broadcast signaling;
the type of base station is configured to represent a type of neighbor base stations;
the type of scanning signal is configured to represent a type of a scanning signal;
the scanning signal is configured to represent the index number of a downlink scanning signal;
when the type of scanning signal is a preamble or reference signal, parameters required in the location corresponding to the scanning signal comprises: a base station effective isotropic radiated power;
when the type of scanning signal is a Ranging signal, parameters required in the location corresponding to the scanning signal comprises: a signal rendezvous time, a Ranging code and a transmission opportunity offset;
the signal rendezvous time is configured to represent the interval time after the mobile station receives the location request signal and before the mobile station sends a Ranging signal;
the Ranging code represents a Ranging signal; and
the transmission opportunity offset represents the time offset for the mobile station sending a Ranging signal.

11. The method of claim 4, wherein
indication elements included in the location request signal comprise: a type of a location method, a response mode indicating information, a recommended number of base stations, a type of base station, a base station index number of neighbor base stations, a type of a scanning signal, a scanning signal and parameters required in the location corresponding to the scanning signal,
the type of location method is configured to represent the adopted location method;
the response mode indicating information is configured to indicate the mode for the mobile station reporting a measuring result; it is unnecessary for a mobile station to report a measuring result when the response mode indicating information indicates it is needless to report a measuring result; when the response mode indicating information is set as the response mode adopted when the mobile station reports a measuring result, the location request signal further includes indication elements of a response period and response parameters;
the response period is configured to indicate the period for the serving base station suggesting the mobile station to report a location response signal before sending a next location request signal;
the response parameter is configured to indicate the measuring parameters that should be reported by the mobile station;
the recommended number of base station is configured to represent the number of the base stations participating in the location recommended by the serving base station;
the type of base station is configured to represent the type of neighbor base stations;
the base station index number of neighbor base stations represents a base station index number of the recommended neighbor base stations participating in the location;
the type of scanning signal is configured to represent the type of a scanning signal;
the scanning signal is configured to represent the index number of a downlink scanning signal;
when the type of scanning signal is a preamble or reference signal, parameters required in the location corresponding to the scanning signal comprises: a base station effective isotropic radiated power;
when the type of scanning signal is a Ranging signal, parameters required in the location corresponding to the scanning signal comprises: a signal rendezvous time, a Ranging code and a transmission opportunity offset;
the signal rendezvous time is configured to represent the interval time after the mobile station receives the location request signal and before the mobile station sends a Ranging signal;
the Ranging code represents a Ranging signal;
the transmission opportunity offset represents the time offset for the mobile station sending a Ranging signal.

12. The method of claim 4, wherein
indication elements included in the location request signal comprise: a type of a location method, the response mode indicating information, an indication for using the base station index bit mapping of the location trigger signaling, a bit mapping length corresponding to the location trigger signal, a bit mapping index corresponding to the location trigger signal, the type of base station, the type of a scanning signal, a scanning signal and parameters required in the location corresponding to the scanning signal,
the type of location method is configured to represent an adopted location method;
the response mode indicating information is configured to indicate the mode for the mobile station reporting a measuring result; it is unnecessary for a mobile station to report a measuring result when the response mode indicating information indicates it is needless to report a measuring result; when the response mode indicating information is set as the response mode adopted when the mobile station reports a measuring result, the location request signal further includes indication elements of a response period and response parameters;
the response period is configured to indicate the period for the serving base station suggesting the mobile station to report a location response signal before sending the next location trigger signal;
the response parameter is configured to indicate the measuring parameters that should be reported by the mobile station;
the indication for using the base station index bit mapping of the location trigger signal is configured to indicate whether to use the base station index bit mapping of the location trigger signal;
the bit mapping length corresponding to the location trigger signal is configured to represent the bit number used in the bit mapping when the information of the recommended base stations participating in the location is given by use of the bit mapping mode identical to the location trigger signal;
the bit mapping index corresponding to the location trigger signal is configured to represent the index indication of neighbor base stations when the information of the recommended base stations participating in the location is given by use of the bit mapping mode identical to the location trigger signal;
the type of base station is configured to represent the type of neighbor base stations;
the type of scanning signal is configured to represent the type of a scanning signal;
the scanning signal is configured to represent the index number of a downlink scanning signal;
when the type of scanning signal is a preamble or reference signal, parameters required in the location corresponding to the scanning signal comprises: a base station effective isotropic radiated power;
when the type of scanning signal is a Ranging signal, parameters required in the location corresponding to the scanning signal comprises: a signal rendezvous time, a Ranging code and a transmission opportunity offset;
the signal rendezvous time is configured to represent the interval time after the mobile station receives the location request signal and before the mobile station sends a Ranging signal;
the Ranging code represents a Ranging signal;
the transmission opportunity offset represents the time offset for the mobile station sending a Ranging signal.

13. The method of claim 4, wherein
the location request signaling further comprises an indication element of configuration change count value configured to represent a neighbor cell broadcast signaling referenced when the signaling is set.

14. The method of claim 4, wherein
the location request signaling further comprises an indication element of request sequence ID for marking each newly-constructed location request signal by the request sequence ID and storing the ID when the serving base station constructs a location request signal; after receiving the location response signal from the mobile station, the serving base station determines whether the request sequence ID of the location response signal is identical to the stored request sequence ID; if the request sequence ID of the location response signal is not identical to the stored request sequence ID, the location response signal is discarded.

15. The method of claim 12, wherein the location request signal further comprises an indication element of trigger sequence ID for representing the location trigger signal corresponding to the location request signal.

16. The method of claim 4, wherein indication elements included in the location response signal comprises: a response mode, an indication for using the base station index bit mapping of a neighbor cell broadcast signaling, response parameters, a bit mapping length corresponding to a neighbor cell broadcast signal, a bit mapping index corresponding to a neighbor cell broadcast signal and the type of base station,
the response mode is configured to indicate the mode for the mobile station reporting a measuring result;
the indication for using the base station index bit mapping of neighbor cell broadcast signaling is configured to indicate whether to use the base station index bit mapping of the neighbor cell broadcast signaling;
response parameters are configured to represent parameters reported in the signaling; the parameters includes any one or the combination of: carrier interference and noise ratio mean of neighbor base station, receiving signal strength indication mean of neighbor base station, relative delay and the round-trip delay of serving base station;
the bit mapping length corresponding to a neighbor cell broadcast signal is used for representing the bit number used in the bit mapping when the base station index bit mapping of a neighbor cell broadcast signal is used;
the bit mapping index corresponding to a neighbor cell broadcast signaling is used for representing the index indication of neighbor base stations when the base station index bit mapping of a neighbor cell broadcast signal is used;
the type of base station is used for representing the type of neighbor base stations.

17. The method of claim 4, wherein
when measuring results of various base stations are reported by used of the count mode, indication elements included in the location response signal comprises: a response mode, the index number of neighbor base stations, response parameters, the base station index number of neighbor base stations and the type of base stations,
the response mode is configured to indicate the mode for the mobile station reporting a measuring result;
the index number of neighbor base stations is configured to represent the number of neighbor base stations involved in the signal;
response parameters are used for representing parameters reported in the signaling; the parameters includes any one or the combination of: carrier interference and noise ratio mean of neighbor base station, receiving signal strength indication mean of neighbor base station, relative delay and the round-trip delay of serving base station;
the type of base station is configured to represent the type of neighbor base stations;
the base station index number of neighbor base stations is configured to represent the base station index number of neighbor base stations when the measuring results of various base stations are given by use of the count mode.

18. The method of claim 4, wherein indication elements included in the location response signal comprises: a response mode, an indication for using the base station index bit mapping of the location request signal, response parameters, a bit mapping length corresponding to the location request signal, a bit mapping index corresponding to the location request signaling and the type of base station,
the response mode is configured to indicate the mode for the mobile station reporting a measuring result;
the indication for using the base station index bit mapping of the location trigger signaling is configured to indicate whether to use the base station index bit mapping of the location request signal;
response parameters are used for representing parameters reported in the signaling; the parameters includes any one or the combination of: carrier interference and noise ratio mean of neighbor base station, receiving signal strength indication mean of neighbor base station, relative delay and the round-trip delay of serving base station;
the type of base station is configured to represent the type of neighbor base stations;
the bit mapping length corresponding to the location request signal represents the bit length of the bit mapping when the measuring results of various base stations are reported according to the base station bit mapping relation of the location request signal;
the bit mapping index corresponding to the location request signal represents the index of neighbor base stations when the measuring results of various base stations are reported according to the base station bit mapping relation of the location request signal.

19. The method of claim 4, wherein the location response signal further comprises an indication element of configuration change count value configured to represent a neighbor cell broadcast signal referenced when the signaling is set.

20. The method of claim 4, wherein the location response signal further comprises an indication element of location request sequence ID configured to represent the location request signal corresponding to the location response signal.

21. The method of claim 5, wherein indication elements included in the location broadcast signal comprises: the number of base station type, the type of base station, the number of base station, the number of base station index, the type/length/value information for representing the position information of neighbor base stations and the base station index number of neighbor base stations,
the number of base station type represents the total number of base station type;
the type of base station is configured to represent the type of base stations;
the number of base station represents the total number of neighbor base stations belonging to each base station type;
the number of base station index represents the total number of neighbor base stations belonging to each base station type determined according to the base station index Table of a neighbor cell broadcast signal;
the type/length/value information includes: long type absolute position, short type absolute position, relative position, GPS time and frequency accuracy,
the long type absolute position and the short type absolute position are three-dimensional coordinates of neighbor base stations, only one of them may be used every time;
the relative position is a position of a neighbor base station relative to the serving base station;
the GPS time is for use in timing synchronization;
the frequency accuracy represents the frequency precision of location;
the base station index number of neighbor base station is a base station index number of a neighbor base station in a neighbor cell broadcast signal.

22. The method of claim 5, wherein indication elements included in the location broadcast signal comprises: the number of base station type, the type of base station, the number of base station, the ID of base station and the type/length/value information configured to represent the position information of neighbor base stations,
the number of base station type represents the total number of base station type;
the type of base station is configured to represent the type of base stations;
the number of base station represents the total number of neighbor base stations belonging to each base station type;
the ID of base station is an unique ID of base station;
the type/length/value information includes: long type absolute position, short type absolute position, relative position, GPS time and frequency accuracy,
the long type absolute position and the short type absolute position are three-dimensional coordinates of neighbor base stations, only one of them may be used every time;
the relative position is a position of a neighbor base station relative to the serving base station;
the GPS time is for use in timing synchronization;
the frequency accuracy represents the frequency precision of location;

23. The method of claim 5, wherein the location broadcast signal further comprises an indication element of configuration change count value configured to represent a neighbor cell broadcast signal referenced when the signaling is set, which is set according to the corresponding count value of the neighbor cell broadcast signal.

24. The method of claim 1, wherein determining comprises: sending, by the serving base station, a location request signaling notifies various base stations participating in the location of ranging signal code and transmission opportunity.

25. A method for implementing the location, the method comprising:
sending, by a serving base station, a page broadcast signal to a mobile station which is in idle state to trigger the location; the page broadcast signal is configured to carry the location service indicating information and the location method indicating information.

26. The method of claim 25, wherein the location service indicating information of the page broadcast signal is configured to indicate whether the page broadcast signal is used for the location; and
the location method indicating information of the page broadcast signal is configured to indicate an adopted location method.

27. A method for broadcasting the position information of neighbor base stations, the method comprising:
broadcasting, by a serving base station, to a mobile station a location broadcast signal carrying the position information of neighbor base stations.

28. The method of claim 27, wherein the location broadcast signal includes indication elements comprising: a number of base stations, a number of base station index, a type/length/value information for representing the position information of neighbor base stations and the base station index number of neighbor base stations,
the number of base station represents the total number of neighbor base stations belonging to each base station type;
the number of base station index represents the total number of neighbor base stations belonging to each base station type determined according to the base station index Table of a neighbor cell broadcast signaling;
the type/length/value information includes: long type absolute position, short type absolute position, relative position, GPS time and frequency accuracy,
the long type absolute position and the short type absolute position are three-dimensional coordinates of neighbor base stations, only one of them may be used every time;
the relative position is a position of a neighbor base station relative to the serving base station;
the GPS time is for use in timing synchronization;
the frequency accuracy represents the frequency precision of location;
the base station index number of neighbor base station is a base station index number of a neighbor base station in a neighbor cell broadcast signal.

29. The method of claim 27, wherein the location broadcast signal includes
indication elements comprising: a number of base station, a ID of base station and a type/length/value information for representing the position information of neighbor base stations,
the number of base station represents the total number of neighbor base stations belonging to each base station type;
the ID of base station is an unique ID of base station;
the type/length/value information includes: long type absolute position, short type absolute position, relative position, GPS time and frequency accuracy,
the long type absolute position and the short type absolute position are three-dimensional coordinates of neighbor base stations, only one of them may be used every time;
the relative position is a position of a neighbor base station relative to the serving base station;
the GPS time is for use in timing synchronization;
the frequency accuracy represents the frequency precision of location;

30. The method of claim 28, wherein
the location broadcast signal further comprises indication elements of: the number of base station type and the type of base station,
the number of base station type represents the total number of base station type;
the type of base station is configured to represent the type of base stations;

31. The method of claim 28, wherein
the location broadcast signal further comprises an indication element of configuration change count value for representing a neighbor cell broadcast signaling referenced when the signaling is set, which is set according to the corresponding count value of the neighbor cell broadcast signal.

32. A method for negotiating the location capability, the method comprising:
sending, by a serving base station, to a mobile station a location capability negotiating request signal to require acquiring the location capability that can be supported by the mobile station;
sending, by the mobile station, to the serving base station a location capability response signal carrying the location capability supported by the mobile station.

33. The method of claim 32, wherein the location capability negotiating request signal includes a location capability type request indication element for representing requesting that the mobile station feeds back its supported location capability;
the location capability negotiating request signal includes a location capability type bit mapping index for representing the location capability supported by the mobile station.

34. A method for negotiating the location capability, the method comprising:
sending, by a mobile station, to a serving base station a system basic capability request signaling or registration request signaling carrying the location capability supported by the mobile station;
sending, by the serving base station, to the mobile station a system basic capability response signaling or registration response signaling carrying the location capability supported by the serving base station after receiving the system basic capability request signaling.

35. The method of claim 34, the method further comprising: adding an indication element of capability for support Global Position System assisted by the network A-GPS indication in the system basic capability request signaling or registration request signaling and the system basic capability response signaling or registration response signaling;
wherein the mobile station carrying its supported location capability in the system basic capability request signaling or registration request signaling comprises: setting the value of capability for support A-GPS indication in the system basic capability request signaling or registration request signaling according to whether the mobile station supports the A-GPS location capability;
and wherein the serving base station carrying its supported location capability in the system basic capability response signaling or registration response signaling comprises: setting the value of capability for support A-GPS indication in the system basic capability response signaling or registration response signaling according to whether the serving base station supports the A-GPS location capability.

36. The method of claim 34, wherein
the method further comprising: adding an indication element of location capability type indication in the system basic capability request signaling or registration request signaling and the system basic capability response signaling or registration response signaling;
wherein the mobile station carrying its supported location capability in the system basic capability request signaling or registration request signaling comprises: carrying, by the mobile station, its supported location capability in the location capability type indication of the system basic capability request signaling or registration response signaling;
and wherein the serving base station carrying its supported location capability in the system basic capability response signaling or registration request signaling comprises: carrying, by the serving base station, its supported location capability in the location capability type indication of the system basic capability response signaling or registration request signaling.

37. A method for implementing the location, the comprising:
sending, by a mobile station, to a serving base station a location trigger signaling carrying the information of the base stations participating in the location and the type of scanning signal;
receiving, by the mobile station, a location request signaling returned by the serving base station; the location request signaling carries the response mode indicating information, the information of the base stations participating in the location, the type of a scanning signal, a scanning signal and parameters required in the location corresponding to the scanning signal.

38. A method for implementing the location, the method comprising:
sending, by a serving base station, a location request signaling to a mobile station; the location request signaling carries the response mode indicating information, the information of the base stations participating in the location, the type of a scanning signal, a scanning signal and the parameters required in the location corresponding to the scanning signal.
